(19) United States
(12) Patent Application Publication
(10) Pub. No.: US 2025/0348555 A1
(43) Pub. Date: Nov. 13, 2025

(54) ELECTRONIC DEVICE AND CONTROL METHOD THEREOF

(71) Applicant: SAMSUNG ELECTRONICS CO., LTD., Suwon-si (KR)

(72) Inventors: Youngman JUNG, Suwon-si (KR); Seok Hong, Suwon-si (KR)

(73) Assignee: SAMSUNG ELECTRONICS CO., LTD., Suwon-si (KR)

(21) Appl. No.: 19/277,853

(22) Filed: Jul. 23, 2025

Related U.S. Application Data
(63) Continuation of application No. PCT/KR2024/001795, filed on Feb. 7, 2024.

(30) Foreign Application Priority Data
Mar. 29, 2023 (KR) 10-2023-0041093

(51) Int. Cl. G06F 18/213; H04L 9/32; H04L 61/255

(52) U.S. Cl. CPC G06F 18/213; H04L 9/3213; H04L 61/255

(57) ABSTRACT

A method of an electronic device, includes: based on a user input for obtaining information on a digital asset being received, receiving, from a first network, an analysis algorithm corresponding to the digital asset; obtaining feature data corresponding to the digital asset based on the received analysis algorithm; transmitting, to the first network, the feature data; receiving, from the first network, token information corresponding to the feature data; and outputting information on the digital asset comprising the received token information.

### CROSS-REFERENCE TO RELATED APPLICATIONS

This application is a by-pass continuation application of International Application No. PCT/KR2024/001795, filed on Feb. 7, 2024, which is based on and claims priority to Korean Patent Application No. 10-2023-0041093, filed on Mar. 29, 2023, in the Korean Intellectual Property Office, the disclosures of which are incorporated by reference herein their entireties.

### BACKGROUND

### 1. Field

The disclosure is directed to an electronic device and a control method of the electronic device, and more particularly, to an electronic device that searches digital asset and a control method of the electronic device.

### 2. Description of Related Art

A digital asset may be in a digital form. The digital asset may be registered (or stored) based on a token(s) or the like. For example, the token may be a non-fungible token (NFT) that is a token having a unique value on a blockchain. The token may be evidence of ownership (or certificate of ownership) of the digital asset.

A user may find the accurate token corresponding to a specific digital asset in order to verify whether the specific digital asset present on-line or off-line is registered as a token. However, it may be difficult for the user to find the token that represents a specific digital asset from among the various tokens directly.

It may be difficult for the user to know how to purchase a specific digital asset, which method is used, and who the owner is, even when trying to purchase the same specific digital asset. In addition, it may be difficult for the user to know whether the specific digital asset is registered as a token, or the like. Further, because copying and changing the digital asset is easy, it may be difficult to verify the ownership for the copied asset.

### SUMMARY

Provided are an electronic device that verifies whether a specific digital asset is registered as a token through a pre-set network and a control method of the electronic device.

According to an aspect of the disclosure, an electronic device includes: a memory storing instructions; a communication interface; and at least one processor configured to execute the instructions, wherein the at least one processor is configured to, based on a user input for obtaining information on a digital asset being received, receive, from a first network through the communication interface, an analysis algorithm corresponding to the digital asset, based on the received analysis algorithm, obtain feature data corresponding to the digital asset, transmit, to the first network through the communication interface, the feature data, receive, from the first network through the communication interface, token information corresponding to the feature data, and output information on the digital asset, wherein the information comprises the received token information.

According to an aspect of the disclosure, a method of an electronic device, includes: based on a user input for obtaining information on a digital asset being received, receiving, from a first network, an analysis algorithm corresponding to the digital asset; obtaining feature data corresponding to the digital asset based on the received analysis algorithm; transmitting, to the first network, the feature data; receiving, from the first network, token information corresponding to the feature data; and outputting information on the digital asset comprising the received token information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an electronic device obtaining a digital asset;

FIG. 2 illustrates an electronic device according to an embodiment of the disclosure;

FIG. 3 illustrates a detailed configuration of the electronic device of FIG. 1;

FIG. 4 illustrates one or more embodiments of performing a processing operation associated with a digital asset;

FIG. 5 illustrates a network which stores NFT;

FIG. 6 is a flowchart illustrating an operation for processing a user input associated with a digital asset;

FIG. 7 illustrates an operation for obtaining token information corresponding to a digital asset;

FIG. 8 is a flowchart illustrating an operation for obtaining token information corresponding to a digital asset;

FIG. 9 is a flowchart illustrating an operation for obtaining token information corresponding to a digital asset based on similarity;

FIG. 10 illustrates an operation for obtaining metadata;

FIG. 11 is a flowchart illustrating an operation for obtaining metadata;

FIG. 12 illustrates a content comparison operation;

FIG. 13 is a flowchart illustrating a content comparison operation;

FIG. 14 illustrates an NFT registration operation;

FIG. 15 is a flowchart illustrating an NFT registration operation;

FIG. 16 illustrates a first network;

FIG. 17 illustrates a mapping table;

FIG. 18 illustrates an NFT and metadata;

FIG. 19 illustrates an operation for outputting an NFT search result;

FIG. 20 illustrates an operation for searching an NFT with only a portion of a digital asset;

FIG. 21 illustrates an NFT purchase operation or an NFT lookup (query) operation;

FIG. 22 illustrates a screen that is output when NFT is not found in a search;

FIG. 23 illustrates an operation for outputting an NFT similar with a digital asset;

FIG. 24 illustrates an operation for analyzing a design resource with respect to a target homepage; and

FIG. 25 illustrates a control method of an electronic device according to an embodiment of the disclosure.

### DETAILED DESCRIPTION

The disclosure will be described in detail below with reference to the accompanying drawings. Terms used in describing embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are simply as its designation and based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression at least one of A and/or B indicates any one of “A” or “B” or “A and B”. Expressions such as “1st”, “2nd”, “first”, or “second” used in the disclosure may limit various elements regardless of order and/or importance, and may be used merely to distinguish one element from another element and not limit the relevant element.

When a certain element (e.g., a first element) is indicated as being “(operatively or communicatively) coupled with/to” or “connected to” another element (e.g., a second element), the certain element is directly coupled with/to the another element or is coupled through other element (e.g., a third element).

A singular expression includes a plural expression, unless otherwise specified. The terms such as “configured” or “include” are used herein to designate a presence of a characteristic, a number, a step, an operation, an element, a component, or their combinations, and not to preclude a presence or a possibility of adding one or more of other characteristics, numbers, steps, operations, elements, components or their combinations.

The term “module” or “part” used herein perform at least one function or operation, and may be implemented with hardware (e.g., a processor, a controller) or software (computer codes), or implemented with a combination of hardware and software. In addition, a plurality of “modules” or a plurality of “parts”, except for a “module” or a “part” which needs to be implemented with a specific hardware, may be integrated in at least one module and implemented as at least one processor.

In the disclosure, the term “user” may refer to a person using an electronic device or a device (e.g., artificial intelligence electronic device) using the electronic device.

The disclosure will be described in greater detail below with reference to the accompanied drawings.

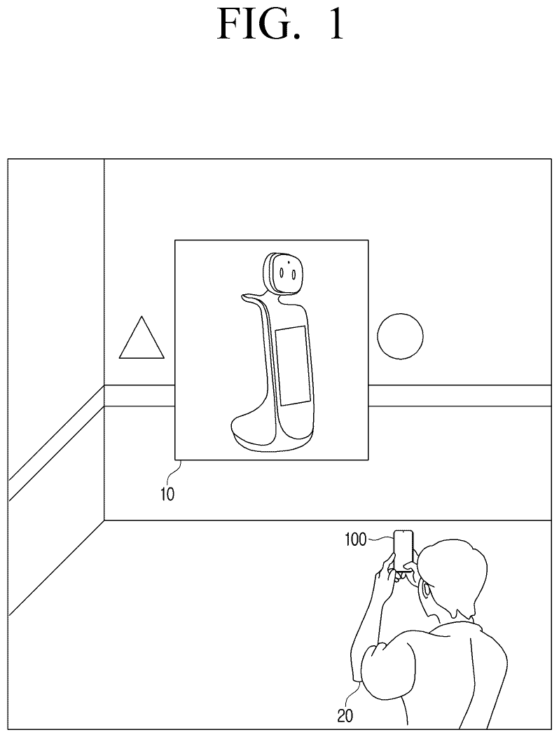

FIG. 1 illustrates an electronic device 100 obtaining a digital asset. Referring to FIG. 1, a user 20 captures a target object 10 using the electronic device 100. The electronic device 100 may obtain an image (or image information) including the target object 10 by a capturing operation of the user 20.

In an example, the target object 10 may be a drawing present in a random space. The target object 10 may be an output drawing. In an example, the target object 10 may be image data displayed at a random space. The target object 10 may be image data output by a display device.

The electronic device 100 may obtain an image including the target object 10. The user 20 may verify whether the image including the target object 10 corresponds to a digital asset. The image including the target object 10 may be described as the digital asset.

The digital asset may mean content expressed as digital data. Content may include at least one from among image data or audio data. According to an embodiment, content may mean digital data in various forms that is provided to the user.

In FIG. 1, the target object 10 has been described as an image. According to another embodiment, the target object 10 may be audio data. In addition, according to another embodiment, the target object 10 may be implemented as a content with an image and audio coupled. Alternatively, according to another embodiment, the target object 10 may be data in a different form that is not an image or audio. In FIG. 1, the target object 10 is present in a random space. According to another embodiment, the target object 10 may be present on-line. For example, the target object 10 may be image data that is uploaded on an internet web page.

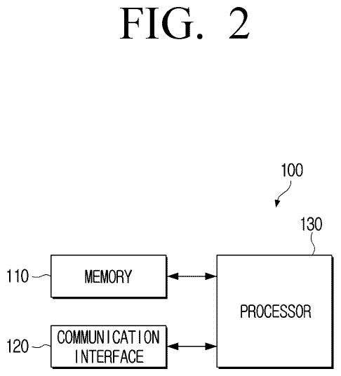

FIG. 2 illustrates the electronic device 100 according to an embodiment of the disclosure. Referring to FIG. 2, the electronic device 100 may include at least one from among a memory 110, a communication interface 120, or at least one processor 130.

The processor 130 may perform an overall control operation of electronic device 100. Specifically, the processor 130 may function controlling the overall operation of electronic device 100.

The electronic device 100 may be configured to search or register information on a digital asset. The memory 110 may store instructions. The communication interface 120 may perform communication with at least one from among a first network 210 or a second network 220. The first network 210 may be a network that stores at least one token (e.g., a non-fungible token (NFT)). The second network 220 may be a network that stores an original digital asset corresponding to a token (or tokens) and various information associated with the original digital asset. The network may be described as a server.

The at least one processor 130 may execute instructions. The at least one processor 130 may receive, based on a user input for obtaining information on a digital asset being received, an analysis algorithm corresponding to the digital asset from the first network 210 through the communication interface 120, obtain feature data corresponding to the digital asset based on the received analysis algorithm, transmit, through the communication interface 120, the feature data to the first network 210, receive, through the communication interface 120, token information corresponding to the feature data from the first network 210, and output information on the digital asset including the received token information.

The digital asset may mean an asset generated in digital (or electronic) form. The digital asset may mean an on-line work in digital form. For example, the digital asset may mean a digital image, a digital audio, an electronic book, software, a media account, a domain name, and the like, but is not necessarily limited thereto.

The at least one processor 130 may receive a user input associated with a digital asset. The user input may be one from among an input for searching for a digital asset or an input for registering the digital asset in a pre-set network, or the like.

The information on the digital asset may mean various information associated with the digital asset. The information on the digital asset may include various information obtained after performing a function on the digital asset. The information on the digital asset may include a search result obtained after performing the function on the digital asset. The search result may include information (token information) associated with an NFT corresponding to the digital asset or metadata information corresponding to the digital asset. The information on the digital asset may include information indicating that the NFT corresponding to the digital asset is not present. The information on the digital asset may include an NFT similar with the digital asset or original data (digital asset) of the similar NFT.

The at least one processor 130 may identify an NFT corresponding to the digital asset input by the user. The at least one processor 130 may obtain token information based on the identified NFT. The digital asset may be described as content, input content, target content, and the like. The at least one processor 130 may use feature data of the digital asset in order to identify the NFT corresponding to the digital asset. The at least one processor 130 may obtain the feature data of the digital asset using the analysis algorithm.

The analysis algorithm may be an algorithm for extracting features of the digital asset. The analysis algorithm may be an algorithm designed such that same feature data is extracted for an original digital asset, a copied digital asset, a modified digital asset, or the like.

For example, the electronic device 100 may obtain feature data on the original digital asset with a specific analysis algorithm. The electronic device 100 may obtain feature data on the copied digital asset (or modified digital asset) with the specific analysis algorithm. If analysis algorithms are the same, the feature data extracted from the original digital asset and the feature data extracted from the copied digital asset (or modified digital asset) may be the same.

The analysis algorithms may be different for each digital asset. In an example, the analysis algorithms for analyzing each of a plurality of digital assets may be different. In an example, the analysis algorithms may be different for each producer (or generator) of each of the plurality of digital assets. A digital asset registered by a first producer may have feature data extracted by using a first analysis algorithm. A digital asset registered by a second producer may have feature data extracted by using a second analysis algorithm.

For example, for the analysis algorithm, a “Rabin's algorithm”, “Cryptographic hash functions”, or a “Perceptual Hash” may be used. If the “Perceptual Hash” is used, the same feature data may be obtained even if quality (resolution, bit rate) of the digital asset is changed. The feature data may mean data that represents the digital asset. The feature data may mean a finger print of the digital asset.

It may be necessary for the at least one processor 130 to obtain the feature data of the digital asset by a pre-set method. This is because an accurate comparison of the feature data included in the NFT may be difficult if the at least one processor 130 extracts the feature data with a random method. There may be a need for the at least one processor 130 to identify the analysis algorithm used in extracting the feature data included in the NFT and extract the feature data corresponding to the digital asset with the identified analysis algorithm.

The at least one processor 130 may extract (or obtain) the feature data of the digital asset using a pre-determined analysis algorithm. The at least one processor 130 may control the communication interface 120 to transmit the feature data for obtaining token information corresponding to the extracted feature data to the first network 210.

The first network 210 may obtain the feature data from the electronic device 100. The first network 210 may obtain the token information corresponding to the feature data. The first network 210 may identify a token including feature data same as the received feature data.

The token may be a digital token (or token). The token may be the non-fungible token (NFT). The token may be distributed and stored in the first network 210. The token may include unique feature data. The feature data of the digital asset input by the user may be described as first feature data, and the unique feature data included in the token may be described as second feature data.

The first network 210 may compare the first feature data with the second feature data and determine whether the first feature data with the second feature data are the same. The first network 210 may identify a token having data same as the first feature data. The first network 210 may obtain token information based on the identified token.

The token information may include various information associated with the token. The token information may include at least one information that has to be provided to the electronic device 100 from among a plurality of information stored in the token. The first network 210 may obtain the token information by selectively extracting at least one information from among the information included in the identified token. The first network 210 may transmit the token information to the electronic device 100.

The at least one processor 130 may receive the token information from the first network 210 through the communication interface 120. The at least one processor 130 may output the information on the digital asset based on the token information. The electronic device 100 receiving the token information may mean that the token corresponding to the first feature data has been identified. Accordingly, the information on the digital asset output based on the token information may include information associated with a token corresponding to the digital asset.

In one embodiment, the at least one processor 130 may output, based on receiving a signal indicating that a token corresponding to the feature data is stored in the first network 210 and the token information from the first network 210, the information on the digital asset including the received token information through the communication interface 120,

The first network 210 may transmit both the token information and a signal indicating the search result to the electronic device 100. When the first network 210 identifies the token corresponding to the first feature data, the first network 210 may generate a signal indicating that the token corresponding to the first feature data has been identified in the first network 210. The first network 210 may transmit the generated signal to the electronic device 100.

The at least one processor 130 may output, based on receiving the signal indicating that the token corresponding to the first feature data has been identified in the first network 210, the information on the digital asset based on the received token information.

In one embodiment, the at least one processor 130 may identify a category of the digital asset, obtain first address information of the first network 210 corresponding to the identified category, and transmit a signal requesting an analysis algorithm to the first network 210 based on the first address information through the communication interface 120.

The at least one processor 130 may use the category of the digital asset to obtain the analysis algorithm. The category of the digital asset may mean an image, an audio, text, a pre-defined form, and the like. The analysis algorithm for extracting the feature data of the digital asset may be different according to the category of the digital asset. The at least one processor 130 may identify the category of the digital asset. The at least one processor 130 may obtain the first address information corresponding to the identified category. The first address information may mean a connection address or a domain of a network in which a specific token is stored. The at least one processor 130 may transmit the signal requesting the analysis algorithm to a specific network using the first address information.

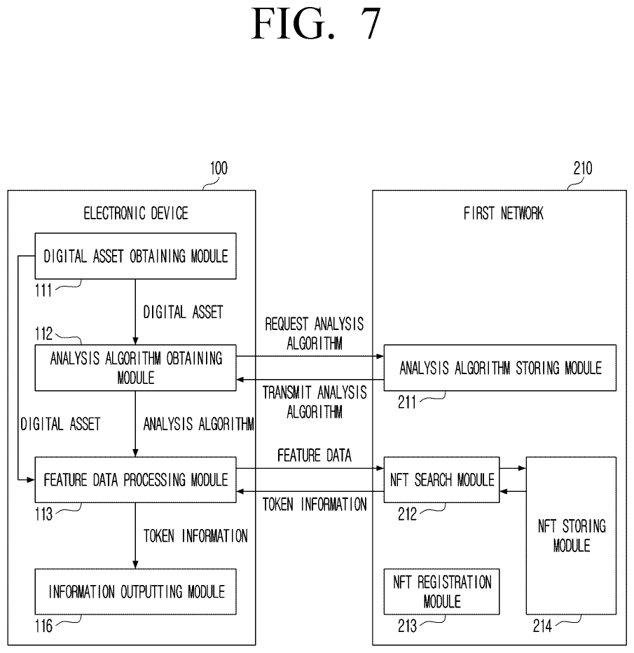

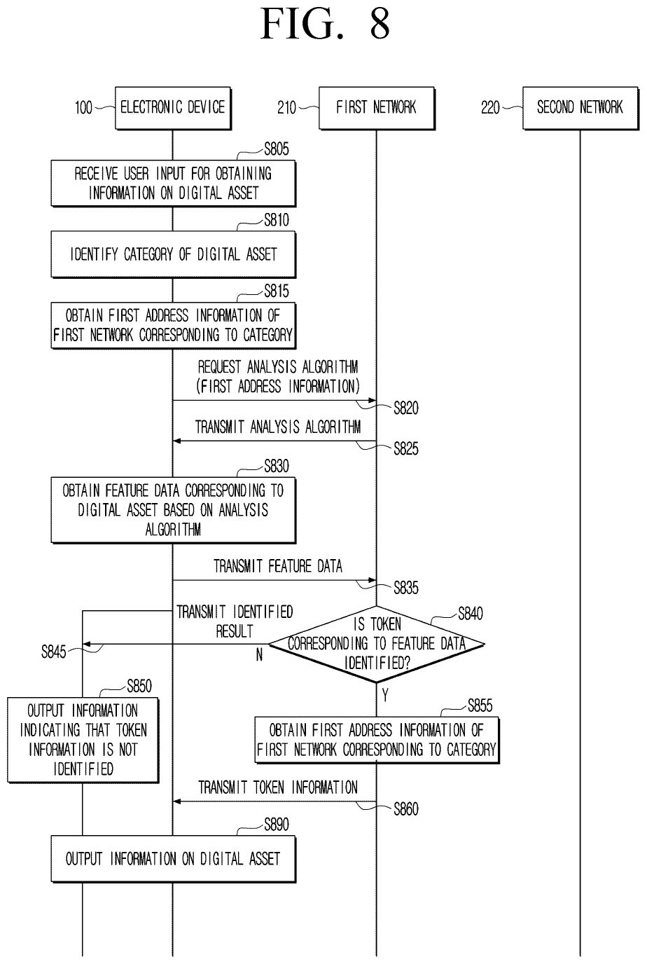

FIG. 7 and FIG. 8 describe an operation for outputting the information on the digital asset using the category. In an example, the network in which the digital asset is stored according to the category may be different. A network in which the digital asset in image form is stored and a network in which the digital asset in audio form is stored may be different.

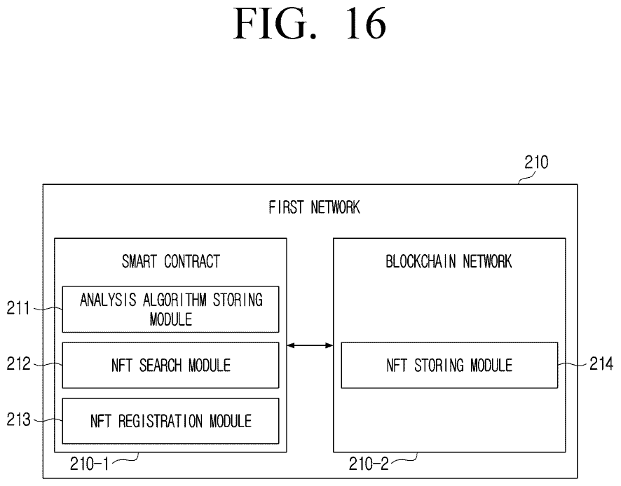

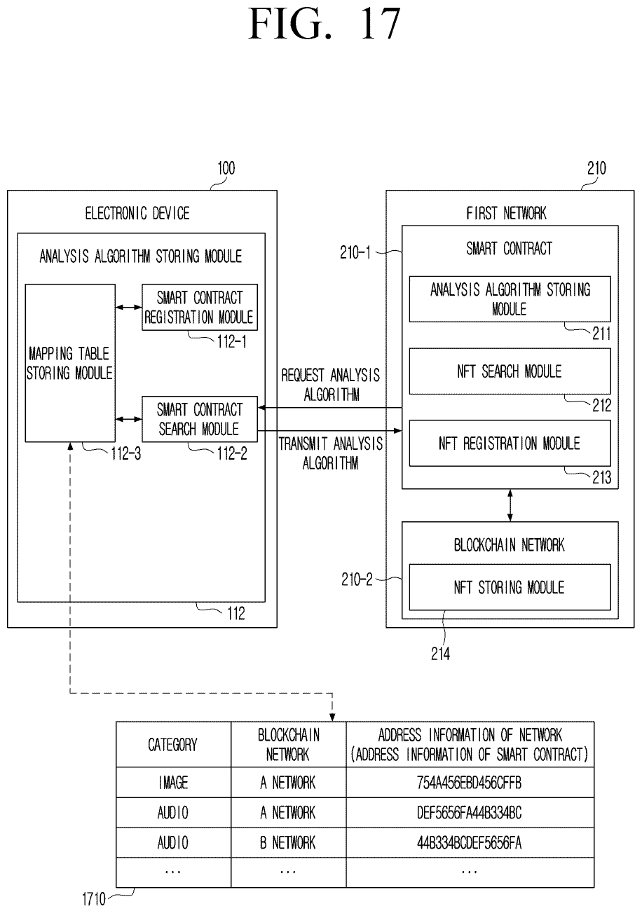

In an example, the networks in which the digital asset is stored may be the same, but smart contracts associated with the digital asset may be different according to the category. A smart contract associated with the digital asset in image form and a smart contract associated with the digital asset in audio form may be different. Descriptions associated with the smart contract will be described in FIG. 16 and FIG. 17.

In one embodiment, the memory 110 may store a mapping table including network address information for each category. The at least one processor 130 may obtain the first address information corresponding to the identified category based on the mapping table stored in the memory. The at least one processor 130 may specify the network to request the analysis algorithm based on the mapping table stored in the memory 110.

The mapping table may be a table mapped with the category of the digital asset and address information of the network corresponding to the digital asset. Detailed descriptions associated therewith will be described in FIG. 17. In one embodiment, the first network 210 may be configured to store the at least one non-fungible token (NFT), and the at least one processor 130 may transmit, to the first network 210, a signal requesting to identify whether the first feature data and the NFT corresponding to the first feature data are included in the first network 210 through the communication interface 120.

The first network 210 may be a blockchain network. The first network 210 may mean a system associated with a blockchain. The at least one processor 130 may specify the first network 210 based on the first address information. The at least one processor 130 may generate a signal requesting to verify whether the token (NFT) corresponding to the first feature data is stored in the first network 210.

The at least one processor 130 may control the communication interface 120 to transmit the generated signal to the first network 210. The generated signal may be a signal requesting to verify whether the token corresponding to the digital asset is registered (or stored). The generated signal may be a signal requesting a token search function.

The first network 210 may perform the token search function in response to a signal transmitted to the electronic device 100. The first network 210 may identify the token (NFT) including the received first feature data. The first network 210 may transmit the identified result to the electronic device 100.

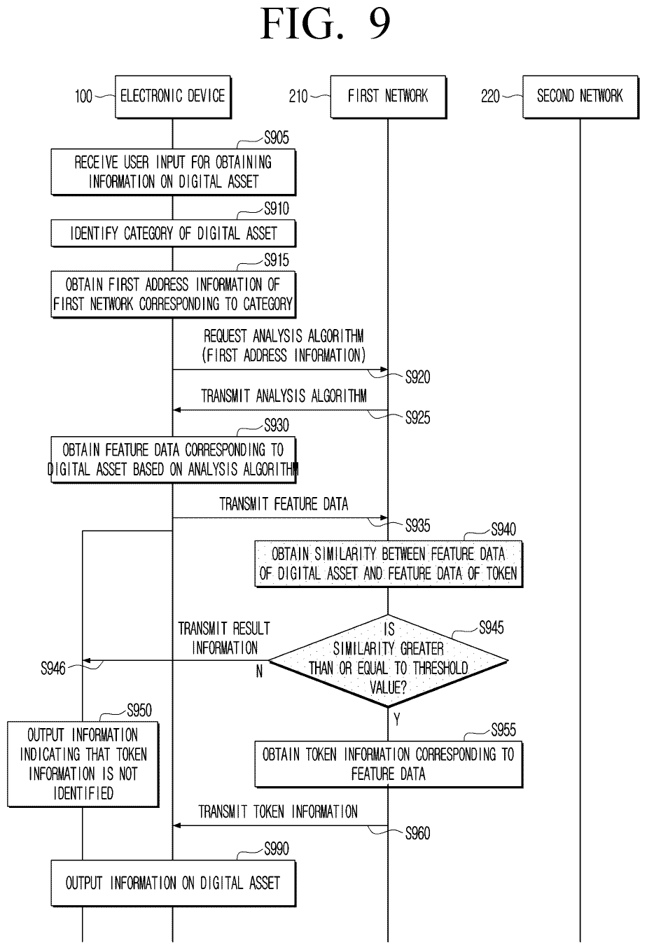

In an example, the first network 210 may identify a token including feature data same as the first feature data. In an example, the first network 210 may identify a token including feature data similar with the first feature data. The first network 210 may identify a token using similarity. Descriptions associated therewith will be described in FIG. 9.

In one embodiment, the token information may include at least one from among identification information of a token, owner information of a token, feature data corresponding to a token, and address information in which metadata corresponding to a token is stored.

The identification information of a token may mean information that represents a token. For example, the identification information of a token may include a block number indicating a token in a blockchain or a block position at which a token is stored.

The owner information of a token may mean information associated with at least one owner who currently owns a token. If selling and purchasing of a token is possible, the owner information of the token may be changed in real-time.

The feature data corresponding to a token may mean the feature data (second feature data) of the digital asset corresponding to a token. When a token is generated, the feature data of the digital asset associated with the token may be extracted in advance. The extracted feature data may be included in the token. This is because a basis of comparison is needed for a future search.

The metadata corresponding to a token may include various information associated with the digital asset. It may be difficult for the metadata to be stored in the token itself due to capacity issues. Accordingly, the metadata may be stored in a separate network. The network in which the metadata is stored may be described as the second network. The address information (second address information) of metadata may mean a digital address for connecting to (or accessing) metadata.

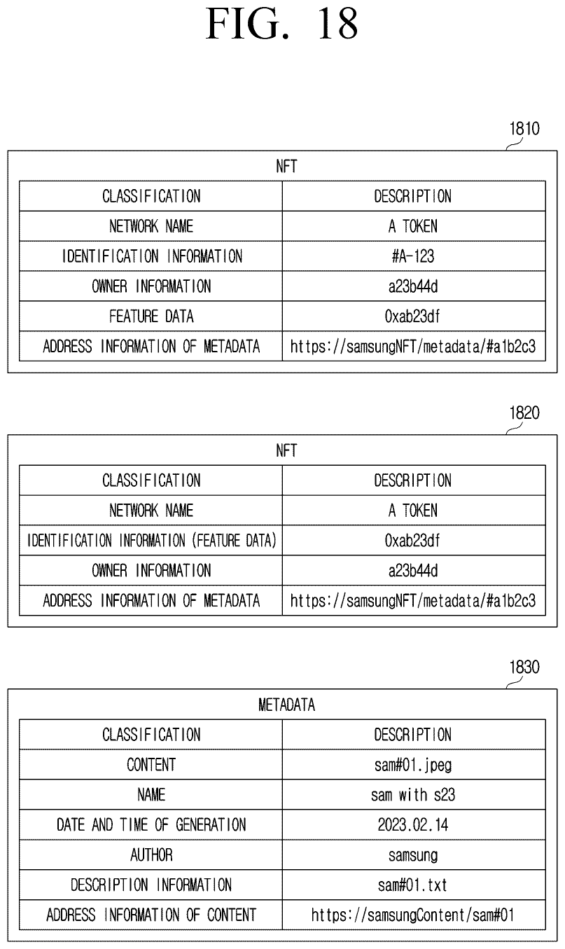

FIG. 18 illustrates detailed description associated with the token. In one embodiment, the at least one processor 130 may obtain second address information in which the metadata corresponding to the token is stored based on the token information, transmit, through the communication interface 120, a signal requesting the metadata to the second network 220 based on the second address information, and receive, through the communication interface 120, the metadata from the second network 220.

The token information may include the digital address (second address information) in which the metadata is stored. The second address information may mean the digital address associated with the second network 220. The token itself may be associated with a specific digital asset (second digital asset), and the token may include the digital address (second address information) in which original data of a second digital asset is stored.

The at least one processor 130 may obtain the second address information through the token information, and control the communication interface 120 to transmit the signal requesting the metadata to the second network 220 based on the second address information. The second network 220 may transmit the metadata to the electronic device 100 in response to the signal transmitted by the electronic device 100. The second network 220 may mean a distributed file system.

In one embodiment, the metadata may include at least one from among content corresponding to a token, a name of a content, a date and time of generation of a content, an author of a content, and description information corresponding to a content. The content corresponding to a token may mean an original digital asset. The original digital asset may be described as the second digital asset. The name of a content may mean a name of a digital asset.

The date and time of generation of a content may include date information on which a producer first generated (or registered) the second digital asset. The author of a content may mean a main agent who initially created the second digital asset. The description information corresponding to a content may include descriptions associated with the second digital asset.

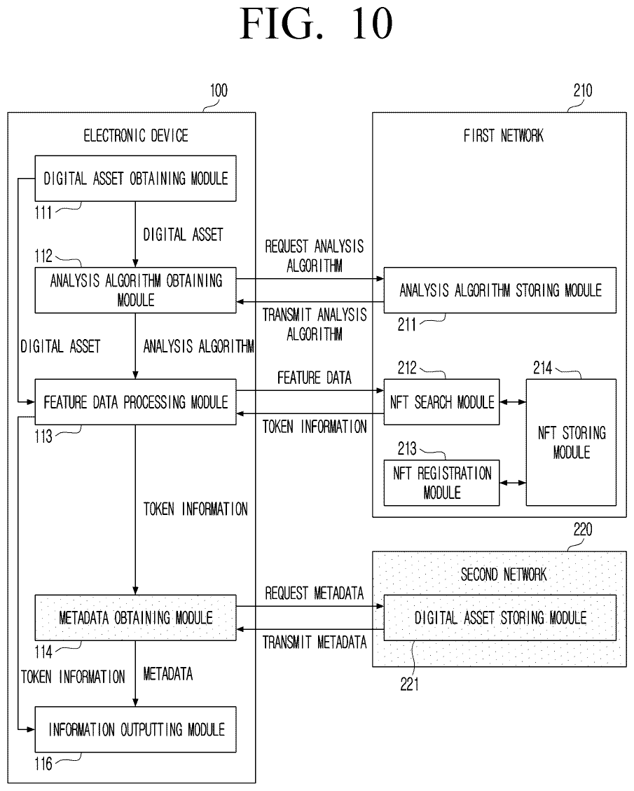

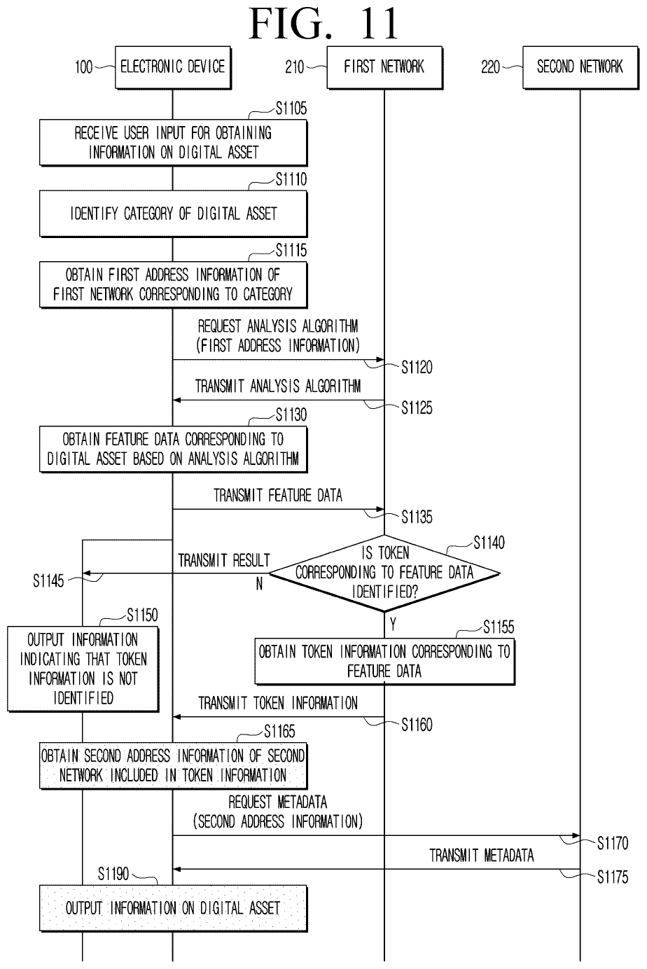

FIG. 10, FIG. 11, and FIG. 18 illustrate detailed descriptions associated with the metadata. In one embodiment, the at least one processor 130 may output the information on the digital asset including at least one from among the token information and the metadata. In an example, the at least one processor 130 may output the information on the digital asset including the token information.

In an example, the at least one processor 130 may output the information on the digital asset including first information which is a portion from among the token information. In an example, the at least one processor 130 may output the information on the digital asset including the metadata. In an example, the at least one processor 130 may output the information on the digital asset including second information which is a portion from among the metadata. In an example, the at least one processor 130 may output the information on the digital asset including the token information and the metadata.

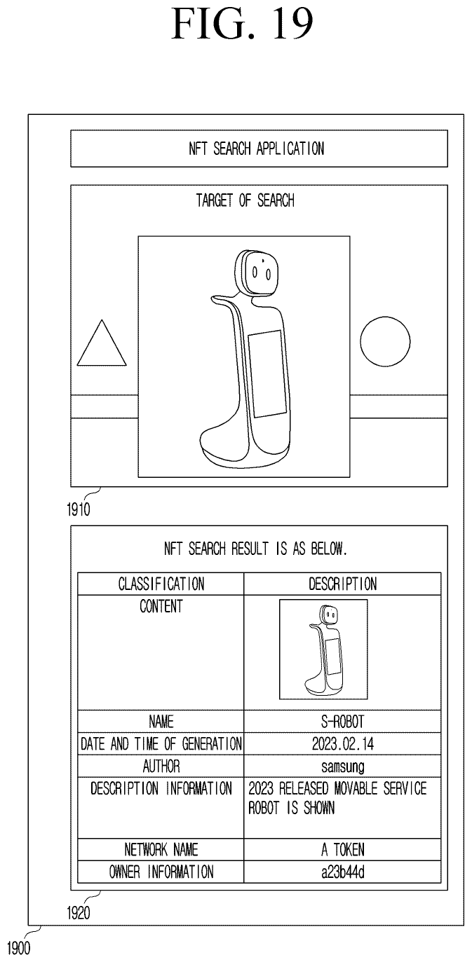

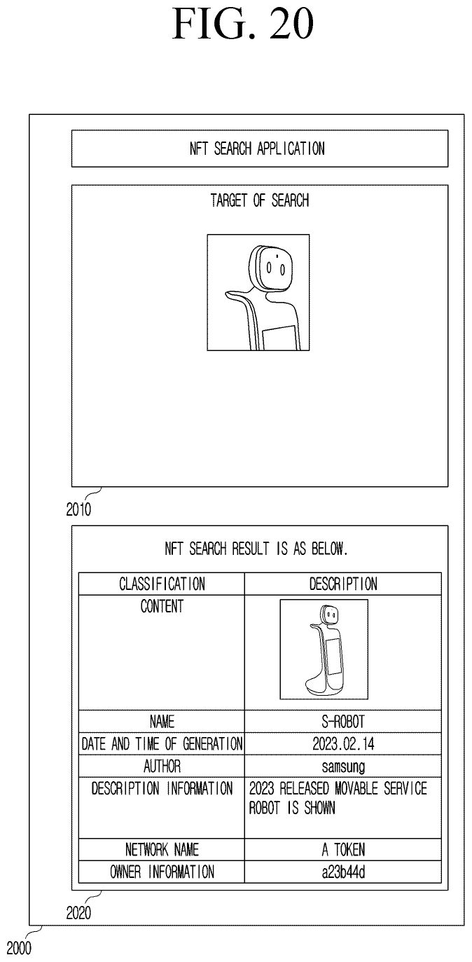

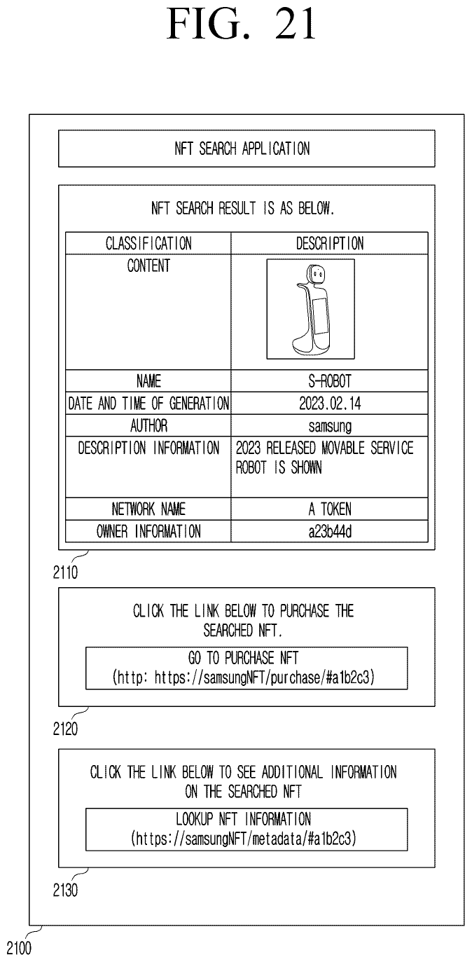

In an example, the at least one processor 130 may output the information on the digital asset including the first information and the second information. The information on the digital asset that is output when the token corresponding to the digital asset is identified will be described in FIG. 19, FIG. 20, and FIG. 21. In one embodiment, the information on the digital asset may be output even when the token corresponding to the digital asset is not identified. In one embodiment, the at least one processor 130 may output, based on receiving a signal indicating that the token corresponding to the feature data is not stored in the first network 210 from the first network 210, information indicating that a token corresponding to input data is not identified through the communication interface 120.

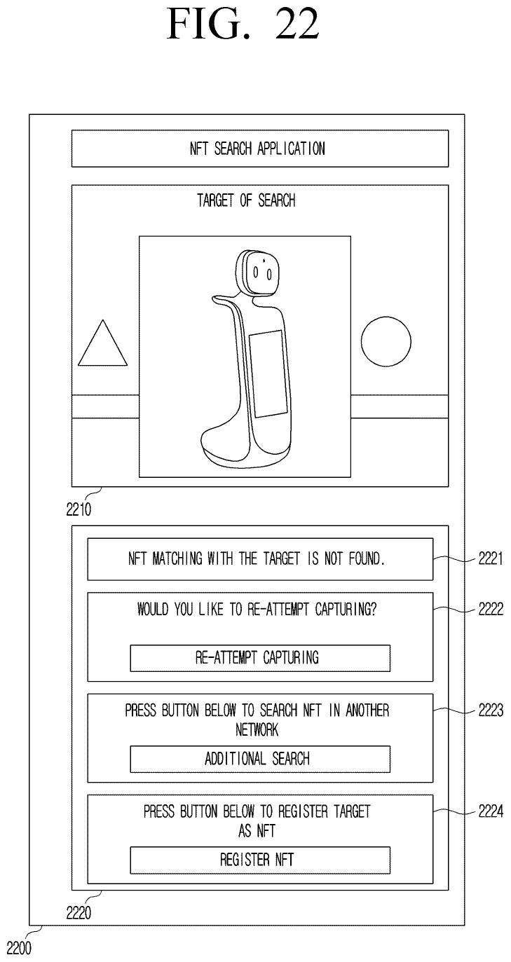

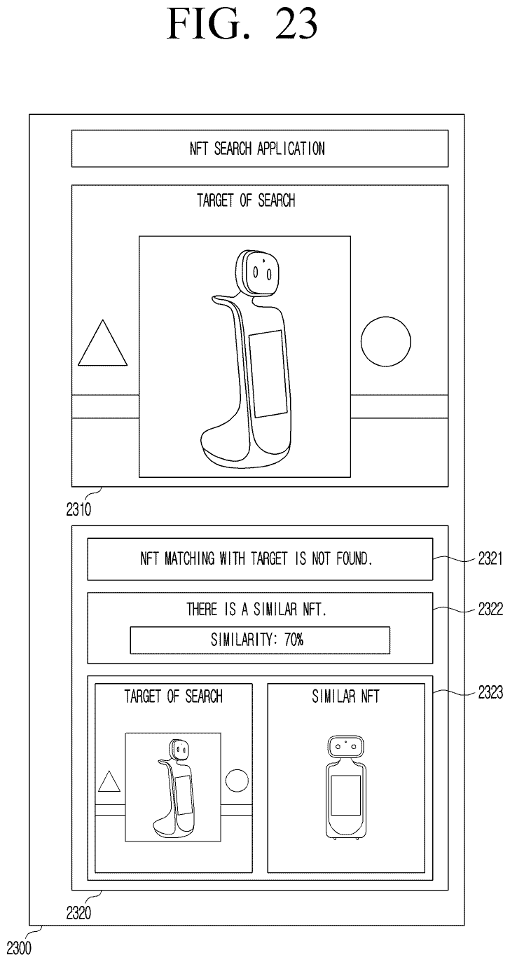

FIG. 22 and FIG. 23 illustrate detailed descriptions associated therewith. In the above-described description, a comparison operation of the feature data has been described as being performed in the first network 210. According to an embodiment, the comparison operation of the feature data may be performed in the electronic device 100. The electronic device 100 may not transmit first feature data of a first digital asset to the first network 210. The first network 210 may transmit second feature data included in a token to the electronic device 100. The electronic device 100 may identify a token corresponding to the digital asset by comparing the second feature data and the first feature data received from the first network 210. If the first network 210 is able to transmit a plurality of second feature data to the electronic device 100, the electronic device 100 may identify a token corresponding to the first feature data by identifying feature data that is same as the first feature data from among the plurality of second feature data.

The electronic device 100 according to one or more embodiments may perform a search operation of the digital asset by extracting the feature data of the digital asset. The user may easily determine whether the digital asset is registered as a token. The electronic device 100 may perform a verification (or search) operation on not only the original data itself but also on a copied version or a modified version of the digital asset.

The electronic device 100 may prevent duplicate registrations of the digital asset. Because the electronic device 100 uses a token (NFT) including feature data (finger print), ownership of the digital asset may be clearly determined. In addition, the user may easily verify the ownership of the digital asset through capturing a photograph, or the like. The original owner of the digital asset may easily identify a token (NFT) registered against his/her intent.

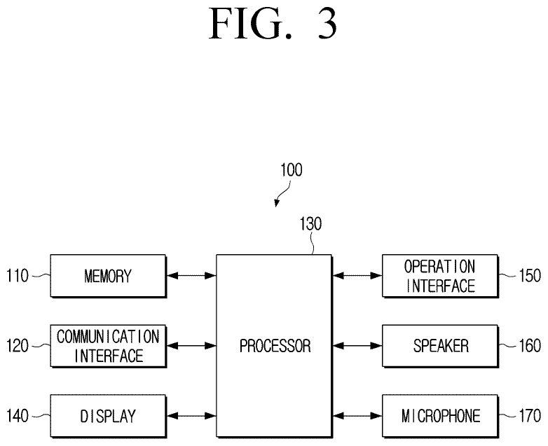

Although only simple configurations that constitute the electronic device 100 have been shown and described above, at implementation, various configurations may be additionally included. The above will be described below with reference to FIG. 3.

FIG. 3 illustrates a detailed configuration of the electronic device 100 of FIG. 1. Referring to FIG. 3, the electronic device 100 may include at least one from among the memory 110, the communication interface 120, the at least one processor 130, a display 140, an operation interface 150, a speaker 160, or a microphone 170. Redundant descriptions of operations that are same as that described above from among the operations of the electronic device 100 will be omitted.

The electronic device 100 according to the one or more embodiments of the disclosure may include at least one from among, for example, a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a MP3 player, a medical device, a camera, or a wearable device. In some embodiments, the electronic device 100 may include at least one from among, for example, a television, a digital video disk (DVD) player, and a media box (e.g., Samsung HomeSync™, Apple TV™, or Google TV™). The above-described examples are merely examples for describing the electronic device and are not necessarily limited to the above-described device.

The memory 110 may be implemented as an internal memory such as, for example, and without limitation, a read only memory (ROM) (e.g., an electrically erasable programmable read-only memory (EEPROM)), a random access memory (RAM), and the like included in the at least one processor 130, or implemented as a memory separate from the at least one processor 130. In this case, the memory 110 may be implemented in a form of a memory embedded in the electronic device 100 according to data storage use, or implemented in a form of a memory attachable to or detachable from the electronic device 100. For example, data for driving of the electronic device 100 may be stored in the memory embedded in the electronic device 100, and data for an expansion function of the electronic device 100 may be stored in the memory attachable to or detachable from the electronic device 100.

In one embodiment, the memory embedded in the electronic device 100 may be implemented as at least one from among a volatile memory (e.g., a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g., NAND flash or NOR flash), a hard disk drive (HDD) or a solid state drive (SSD)). The memory attachable to or detachable from the electronic device 100 may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., a USB memory) connectable to a USB port, or the like.

The communication interface 120 may be a configuration for performing communication with external devices of various types according communication methods of various types. The communication interface 120 may include a wireless communication module or a wired communication module. Each communication module may be implemented in at least one hardware chip form. The wireless communication module may be a module for communicating with the external device via wireless communication. For example, the wireless communication module may include at least one module from among a Wi-Fi module, a Bluetooth module, an infrared communication module, or other communication modules.

The Wi-Fi module and the Bluetooth module may perform communication in the Wi-Fi method and the Bluetooth method, respectively. When using the Wi-Fi module or the Bluetooth module, various connection information such as a service set identifier (SSID) and a session key may first be transmitted and received, and may transmit and receive various information after communicatively connecting using the same. The infrared communication module may perform communication according to an infrared communication (Infrared Data Association (IrDA)) technology of transmitting data wirelessly in short range by using infrared rays present between visible rays and millimeter waves.

The other communication modules may include at least one communication chip that performs communication according to various wireless communication standards such as, for example, and without limitation, ZigBee, 3rd Generation (3G), 3rd Generation Partnership Project (3GPP), Long Term Evolution (LTE), LTE Advanced (LTE-A), 4th Generation (4G), 5th Generation (5G), and the like, in addition to the above-described communication methods. The wired communication module may be a module for communicating with the external device via wired communication. For example, the wired communication module may include at least one from among a local area network (LAN) module, an Ethernet module, a pair cable, a coaxial cable, an optical fiber cable, or an ultra-wide-band (UWB) module.

The processor 130 may be implemented as a digital signal processor (DSP) for processing digital signals, a microprocessor, or a time controller (TCON). However, the embodiment is not limited thereto, and may include one or more from among a central processing unit (CPU), a micro controller unit (MCU), a micro processing unit (MPU), a controller, an application processor (AP), a graphics-processing unit (GPU), a communication processor (CP), or Advanced Reduced instruction set computer (RISC) Machines (ARM) processor, or may be defined by a relevant term. In addition, the processor 130 may be implemented as a System on Chip (SoC) or a large scale integration (LSI) in which a processing algorithm is embedded, and may be implemented in a form of a field programmable gate array (FPGA). In addition, the processor 130 may perform various functions by executing computer executable instructions stored in the memory.

The display 140 may be implemented as displays of various forms such as, for example, and without limitation, a liquid crystal display (LCD), an organic light emitting diode (OLED) display, a plasma display panel (PDP), and the like. In the display 140, a driving circuit, which may be implemented in a form of an amorphous silicon thin film transistor (a-si TFT), a low temperature poly silicon (LTPS) TFT, an organic TFT (OTFT), or the like, a backlight unit, and the like may be included. In one embodiment, the display 140 may be implemented as a touch screen coupled with a touch sensor, a flexible display, a three-dimensional display (3D display), or the like. In addition, according to an embodiment of the disclosure, the display 140 may include, not only a display panel that outputs images, but also a bezel that houses the display panel. Specifically, according to an embodiment of the disclosure, the bezel may include a touch sensor for sensing a user interaction.

The operation interface 150 may be implemented as device such as a button, a touch pad, a mouse, and a keyboard, or implemented as a touch screen capable of performing the above-described display function and an operation input function together therewith. The button may be buttons of various types such as a mechanical button, a touch pad, or a wheel which is formed at a random area at a front surface part or a side surface part, a rear surface part, or the like of an exterior of a main body of the electronic device 100. The speaker 160 may be an element which outputs not only various audio data, but also various notification sounds, voice messages, or the like.

The microphone 170 may be a configuration for receiving input of a user voice or other sounds and converting to audio data. The microphone 170 may receive the user voice in an activated state. For example, the microphone 170 may be formed as an integrated-type at an upper side or a front surface direction, a side surface direction or the like of the electronic device 100. The microphone 170 may include various configurations such as, for example, and without limitation, a microphone that collects the user voice in an analog form, an amplifier circuit that amplifies the collected user voice, an A/D converter circuit that samples the amplified user voice and converts to a digital signal, a filter circuit that removes noise components from the converted digital signal, and the like.

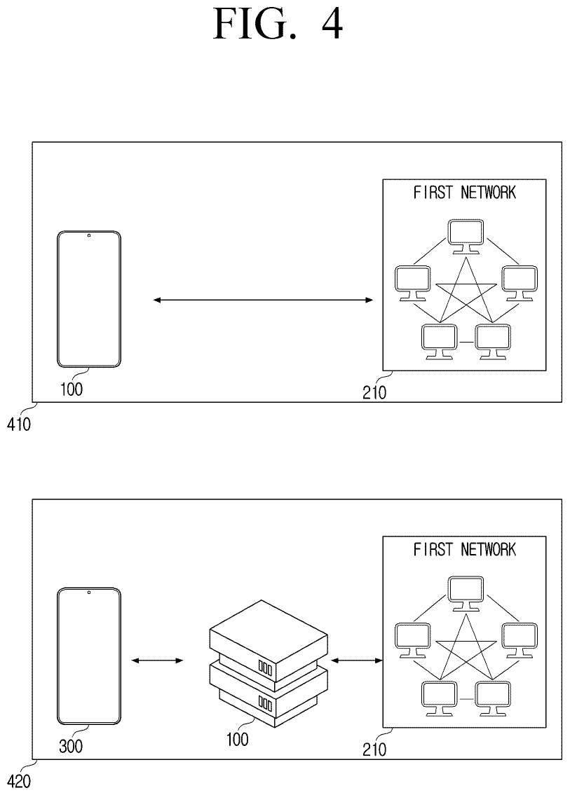

FIG. 4 illustrates one or more embodiments of performing a processing operation associated with a digital asset. In embodiment 410 of FIG. 4, the electronic device 100 may be a device that includes a display. The electronic device 100 may mean a terminal device of the user. The electronic device 100 may obtain the information on the digital asset using the first network 210.

The first network 210 may be a network that stores information associated with at least one digital asset. The first network 210 may identify whether the digital asset, which was requested by the electronic device 100 to be verified, is pre-registered (or pre-stored). The first network 210 may transmit the identified result to the electronic device 100.

In embodiment 420 of FIG. 4, the electronic device 100 may be an independent server. The electronic device 100 may receive the digital asset (or input content) from a terminal device 300 of the user. The electronic device 100 may obtain the information on the digital asset using the first network 210.

The terminal device 300 may mean a user device. The terminal device 300 may transmit the digital asset selected by the user to the electronic device 100. The electronic device 100 may obtain the information on the digital asset received through the terminal device 300 using the first network 210.

According to one or more embodiments, processing operations associated with the digital asset may be performed in different forms from that of the embodiments 410 and 420 in FIG. 4.

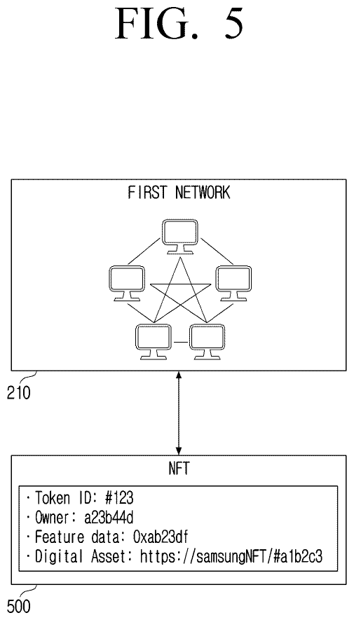

FIG. 5 illustrates the first network 210 which stores NFT. Referring to FIG. 5, the first network 210 may be a network for storing a non-fungible token (NFT) 500. The first network 210 may register and store the NFT 500 according to a request by the user. The NFT 500 may be stored in an encrypted form in at least one node (or device) included in the first network 210. The NFT 500 may be stored in at least one node in a distributed form.

A specific NFT 500 from among the at least one NFT 500 stored in the first network 210 may include at least one from among identification information (e.g., #123) of a token, owner information (e.g., a23b44d) of a token, feature data (e.g., Oxab23df) of a token, and address information (e.g., https://samsungNFT/#alb2c3) in which metadata associated with a digital asset of a token is stored.

The identification information of a token may be an identifier for distinguishing the NFT. The owner information may include a wallet address of an account that owns a blockchain. The NFT 500 may be recorded on a blockchain, and an original data of the digital asset represented by the NFT 500 may be stored in a separate network that is not the blockchain.

Because the digital asset relatively corresponds to large-capacity, the NFT 500 may include a uniform resource identifier (URI) of the digital asset. The uniform resource identifier may be described as position information or address information. In an example, the first network 210 may store one NFT 500. In an example, the first network 210 may store a plurality of NFTs. Each of the plurality of NFTs may mean a tokens in which a plurality of digital assets are registered, respectively. In an example, the NFT 500 may use Ethereum NFT standard (ERC-721) as a default. The NFT 500 may be a format which additionally includes feature data in ERC-721.

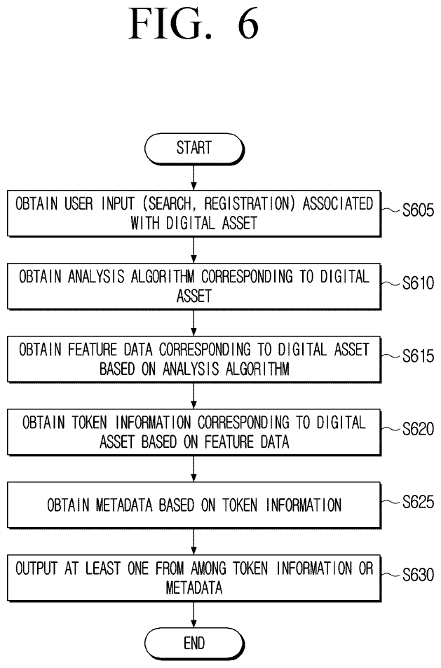

FIG. 6 is a flowchart illustrating an operation for processing a user input associated with a digital asset. Referring to FIG. 6, the electronic device 100 may obtain a user input associated with the digital asset (S605). The user input associated with the digital asset may include one from among a user input requesting a search of the digital asset or a user input requesting registration of the digital asset.

The electronic device 100 may obtain an analysis algorithm corresponding to the digital asset (S610). The analysis algorithm may mean a method for analyzing the digital asset. The analysis algorithm may mean a method for extracting a feature for specifying the digital asset. The electronic device 100 may analyze the digital asset using the analysis algorithm.

The electronic device 100 may obtain the feature data corresponding to the digital asset based on the analysis algorithm (S615). The feature data may mean a finger print. The feature data may be data for specifying the digital asset. If the digital asset are different, the feature data may be different. The feature data corresponding to the digital asset may be different according to the analysis algorithm. The electronic device 100 may obtain (or extract) the feature data corresponding to the digital asset using a pre-determined analysis algorithm.

The electronic device 100 may obtain the token information corresponding to the digital asset based on the feature data (S620). The electronic device 100 may obtain the token information from a token (NFT) associated with the digital data. The token information may mean information included in the token associated with the digital asset.

The electronic device 100 may obtain the metadata based on the token information (S625). The token information may include address information (second address information) for obtaining the metadata associated with the digital asset. The electronic device 100 may obtain the address information (second address information) included in the token information. The electronic device 100 may obtain the metadata corresponding to the digital asset based on the address information (second address information).

The electronic device 100 may output at least one from among the token information or the metadata (S630). The electronic device 100 may generate a user interface (UI) including at least one from among the token information or the metadata. The electronic device 100 may output (or provide) the generated UI. The electronic device 100 may generate the UI based on at least one first information from among a plurality of information included in the token information and at least one second information from among a plurality of information included in the metadata.

FIG. 7 illustrates an operation for obtaining token information corresponding to a digital asset. Referring to FIG. 7, the electronic device 100 may include at least one from among a digital asset obtaining module 111, an analysis algorithm obtaining module 112, a feature data processing module 113, and an information outputting module 116. The first network 210 may include at least one from among an analysis algorithm storing module 211, an NFT search module 212, an NFT registration module 213, and an NFT storing module 214.

The digital asset obtaining module 111 may obtain the digital asset (or input content) selected (or input) by the user. The digital asset obtaining module 111 may transmit the obtained digital asset to the analysis algorithm obtaining module 112. The digital asset obtaining module 111 may transmit the digital asset to the feature data processing module 113.

The analysis algorithm obtaining module 112 may obtain the analysis algorithm based on the digital asset obtained from the digital asset obtaining module 111. The analysis algorithm obtaining module 112 may obtain the first address information corresponding to the category (or type) of the digital asset. The analysis algorithm obtaining module 112 may obtain the first address information corresponding to the digital asset based on a pre-stored mapping table (e.g., 1710 in FIG. 17). The first address information may be information for connecting to (or accessing) the first network 210.

The analysis algorithm obtaining module 112 may connect to (or access) the first network 210 based on the first address information. The analysis algorithm obtaining module 112 may request the analysis algorithm to the analysis algorithm storing module 211 of the first network 210 based on the first address information.

The analysis algorithm storing module 211 included in the first network 210 may receive the analysis algorithm request from the electronic device 100. The analysis algorithm storing module 211 may transmit the stored analysis algorithm to the electronic device 100. The analysis algorithm obtaining module 112 may receive the analysis algorithm from the analysis algorithm storing module 211. The analysis algorithm obtaining module 112 may transmit the analysis algorithm to the feature data processing module 113.

The feature data processing module 113 may receive the digital asset from the digital asset obtaining module 111. The feature data processing module 113 may receive the analysis algorithm from the analysis algorithm obtaining module 112. The feature data processing module 113 may obtain (or extract) the feature data based on the analysis algorithm.

The feature data processing module 113 may transmit the obtained feature data to the first network 210. The feature data processing module 113 may transmit the feature data to the NFT search module 212 of the first network 210.

The NFT search module 212 may receive the feature data from the feature data processing module 113 of the electronic device 100. The NFT search module 212 may verify (or identify) the pre-stored NFT based on the feature data received from the feature data processing module 113. The NFT search module 212 may specify (or identify) the NFT corresponding to the feature data received from the feature data processing module 113 from among the at least one NFT stored in the NFT storing module 214.

When the NFT corresponding to the feature data received from the feature data processing module 113 is identified, the NFT search module 212 may obtain the token information based on the identified NFT. The token information may mean information included in the NFT. The NFT search module 212 may transmit the obtained token information to the electronic device 100.

In an example, the NFT search module 212 may transmit the token information to the feature data processing module 113. According to an embodiment, a target for transmitting the token information may be a module that is not the feature data processing module 113.

The electronic device 100 may receive the token information from the first network 210. The feature data processing module 113 may receive the token information from the NFT search module 212. The feature data processing module 113 may transmit the received token information to the information outputting module 116.

The information outputting module 116 may output the received token information. The information outputting module 116 may generate a UI based on the token information. The information outputting module 116 may provide (or output) the generated UI.

For example, the information outputting module 116 may generate a screen for providing the information on the digital asset based on the token information. The information outputting module 116 may provide the generated screen to the user.

FIG. 8 is a flowchart illustrating an operation for obtaining token information corresponding to a digital asset.

Referring to FIG. 8, the electronic device 100 may receive a user input for obtaining the information on the digital asset (S805). The user input for obtaining the information on the digital asset may be a user input for verifying whether the digital asset is pre-registered in a specific network. The electronic device 100 may obtain (or receive) the digital asset. The digital asset may mean content selected by the user.

The electronic device 100 may identify the category (or type) of the digital asset (S810). The electronic device 100 may obtain the first address information of the first network 210 corresponding to the identified category (S815). The electronic device 100 may obtain the first address information corresponding to the category based on a mapping table. Detailed descriptions associated with the mapping table will be described in FIG. 17. The first address information may mean a web address for accessing (or connecting to) the first network 210.

The electronic device 100 may request the analysis algorithm to the first network 210 based on the first address information (S820). The electronic device 100 may transmit a signal requesting the analysis algorithm to the first network 210. The transmitted signal may include the first address information.

The first network 210 may receive the analysis algorithm request from the electronic device 100. The first network 210 may transmit the analysis algorithm to the electronic device 100 in response to the received request (S825).

The electronic device 100 may receive the analysis algorithm from the first network 210. The electronic device 100 may obtain the feature data corresponding to the digital asset based on the analysis algorithm (S830). The electronic device 100 may transmit the feature data to the first network 210 (S835). The electronic device 100 may transmit the feature data to the first network 210 based on the first address information obtained in step S815. Step 835 may include an operation requesting for the electronic device 100 to verify whether the feature data is pre-stored (or pre-registered) in the first network 210 to the first network 210.

The first network 210 may obtain the feature data from the electronic device 100. The first network 210 may determine whether the token corresponding to the feature data is identified (S840). The token may mean the NFT. The token may include respective unique feature data. The first network 210 may determine whether the feature data received from the electronic device 100 is a match with the feature data stored in the specific NFT.

The feature data of the digital asset may be described as the first feature data. The feature data stored in the NFT may be described as the second feature data.

If the token corresponding to the feature data (first feature data) of the digital asset is not identified (S840-N), the electronic device 100 may transmit the identified result to the first network 210 (S845). The identified result may include information indicating that the token including the feature data (first feature data) of the digital asset in the first network 210 could not be identified.

The electronic device 100 may receive the identified result from the first network 210. The electronic device 100 may output information indicating that the token information is not identified (S850).

If the token corresponding to the feature data (first feature data) of the digital asset is identified (S840-Y), the first network 210 may obtain the token information corresponding to the feature data (first feature data) (S855). The first network 210 may identify the token corresponding to the feature data (first feature data). The first network 210 may obtain at least one information from among a plurality of information included in the identified token as the token information. The first network 210 may transmit the token information to the electronic device 100 (S860).

The electronic device 100 may receive the token information from the first network 210. The electronic device 100 may output (or provide) the information on the digital asset based on the received token information (S890). The information on the digital asset may mean result information (or screen information) generated based on the token information.

In an example, the information on the digital asset may include all token information.

In an example, the information on the digital asset may include a portion of information from among the plurality of information included in the token information.

FIG. 9 is a flowchart illustrating an operation for obtaining token information corresponding to a digital asset based on similarity.

Steps S905, S910, S915, S920, S925, S930, S935, S950, S955, S960, and S990 in FIG. 9 may correspond to steps S805, S810, S815, S820, S825, S830, S835, S850, S855, S860, and S890. Accordingly, redundant descriptions of those steps will be omitted.

After the first network 210 receives the feature data from the electronic device 100, the first network 210 may obtain the similarity between the feature data (first feature data) of the digital asset and the feature data (second feature data) of the token (S940). The first network 210 may store a plurality of tokens. The first network 210 may identify (or compare) whether the feature data (second feature data) stored in each of the plurality of tokens match with the first feature data of the digital asset.

The first network 210 may identify whether the similarity is greater than or equal to a threshold value (S945). The threshold value may be a basis for determining whether the digital asset and the content (or digital asset) corresponding to the registered token are a match. The digital asset which the user requested to verify may not fully match with the original data. Accordingly, the first network 210 may determine whether the token corresponding to the digital asset can be identified using the similarity and the threshold value.

If the similarity is less than the threshold value (S945-N), the electronic device 100 may transmit the result information to the electronic device 100 (S946). The result information that is transmitted may include the similarity.

The electronic device 100 may receive the result information from the first network 210. The result information may include information indicating that the token corresponding to the first feature data of the digital asset is not present in the first network 210. The electronic device 100 may output information indicating that the token information is not identified (S950).

If the similarity is greater than or equal to the threshold value (S945-Y), the electronic device 100 may obtain the token information corresponding to the feature data (first feature data) (S955). Then, the first network 210 may transmit the token information to the electronic device 100 (S960).

The electronic device 100 may receive the token information from the first network 210. The electronic device 100 may output the information on the digital asset based on the token information (S990).

FIG. 10 illustrates an operation for obtaining metadata.

The digital asset obtaining module 111, the analysis algorithm obtaining module 112, the feature data processing module 113, the information outputting module 116, the analysis algorithm storing module 211, the NFT search module 212, the NFT registration module 213, and the NFT storing module 214 in FIG. 10 may correspond to the modules described in FIG. 7. Accordingly, redundant descriptions of those elements will be omitted.

Referring to FIG. 10, the electronic device 100 may further include a metadata obtaining module 114. The metadata obtaining module 114 may obtain the metadata associated with the digital asset. The feature data processing module 113 may transmit the obtained token information to the metadata obtaining module 114. The metadata obtaining module 114 may receive the token information from the metadata obtaining module 114.

The metadata obtaining module 114 may request the metadata to the second network 220 based on the token information. The metadata obtaining module 114 may obtain the second address information included in the token information. The second address information may indicate a web address of the network (second network) in which the metadata is stored. The second address information may mean the web address at which metadata corresponding to a specific content (or digital asset) is stored. The metadata obtaining module 114 may request the metadata to the second network 220 based on the second address information.

The second network 220 may be a network storing at least one metadata. The second network 220 may include a digital asset storing module 221.

The digital asset storing module 221 of the second network 220 may transmit specific metadata to the metadata obtaining module 114 in response to a metadata request received from the metadata obtaining module 114.

The metadata obtaining module 114 may receive the metadata from the second network 220. The metadata obtaining module 114 may transmit the received metadata to the information outputting module 116. The feature data processing module 113 may transmit the token information to the information outputting module 116.

The information outputting module 116 may receive the token information from the feature data processing module 113. The information outputting module 116 may receive the metadata from the metadata obtaining module 114. The information outputting module 116 may output the information on the digital asset based on at least one from among the token information or the metadata.

FIG. 11 is a flowchart illustrating an operation for obtaining metadata.

Steps S1105, S1110, S1115, S1120, S1125, S1130, S1135, S1140, S1145, S1150, S1155, S1160, and S1190 in FIG. 11 may correspond to steps S805, S810, S815, S820, S825, S830, S835, S840, S845, S850, S855, S860, and S890. Accordingly, redundant descriptions of the above steps will be omitted.

After the electronic device 100 receives the token information from the first network 210, the electronic device 100 may obtain the second address information of the second network 220 included in the token information (S1165). The electronic device 100 may request the metadata to the second network 220 based on the second address information (S1170).

The second network 220 may receive the signal requesting the metadata from the electronic device 100. The second network 220 may obtain (or identify) the metadata corresponding to the second address information in response to the metadata request. The second network 220 may transmit the identified metadata to the electronic device 100 (S1175).

The electronic device 100 may receive the metadata from the second network 220. The electronic device 100 may output the information on the digital asset based on at least one from among the token information received in step S1160 or the metadata received in step S1175 (S1190). The information on the digital asset may be information obtained based on at least one from among the token information or the metadata.

The electronic device 100 may generate the information on the digital asset based on at least one from among the first information included in the token information or the second information included in the metadata. The electronic device 100 may output the generated information on the digital asset.

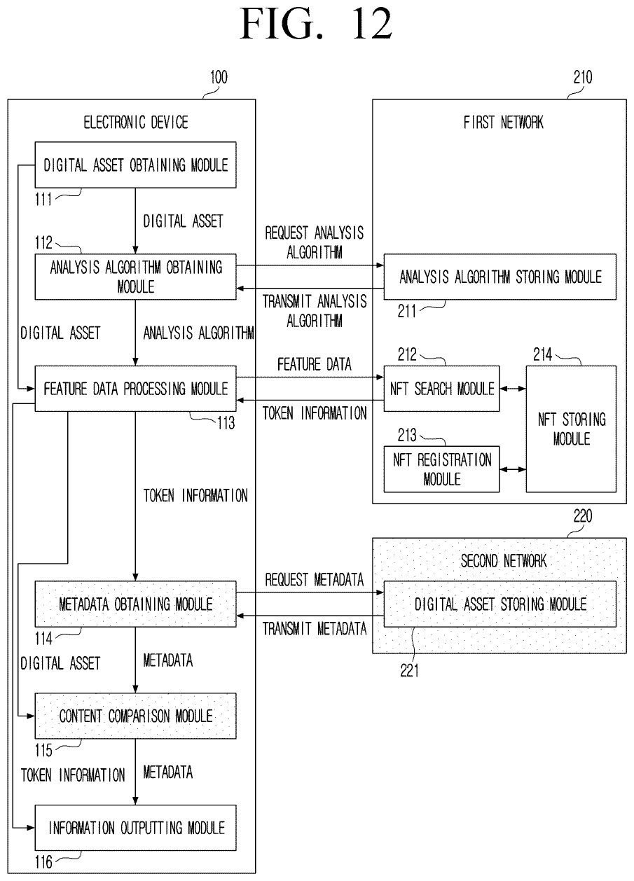

FIG. 12 illustrates a content comparison operation.

The digital asset obtaining module 111, the analysis algorithm obtaining module 112, the feature data processing module 113, the metadata obtaining module 114, the information outputting module 116, the analysis algorithm storing module 211, the NFT search module 212, the NFT registration module 213, the NFT storing module 214, and the digital asset storing module 221 in FIG. 12 may correspond to the modules described in FIG. 10. Accordingly, redundant descriptions of the above elements will be omitted.

Referring to FIG. 12, the electronic device 100 may further include a content comparison module 115. The content comparison module 115 may be a module that directly compares the digital asset selected by the user with the digital asset included in the metadata.

The digital asset selected by the user may be described as the first digital asset or a first content. The digital asset selected by the user may mean a digital asset directly selected by the user to request verification.

The digital asset included in the metadata may be described as the second digital asset or a second content. The digital asset included in the metadata may mean original data.

The content comparison module 115 may determine whether the first digital asset and the second digital asset are the same. If the first digital asset and the second digital asset are identified as the same, the content comparison module 115 may transmit the metadata to the information outputting module 116.

The NFT search module 212 of the first network 210 may identify the token corresponding to the feature data of the digital asset selected by the user. Despite the above, the original data and the digital asset may be compared once more through the content comparison module 115. This is to increase accuracy for whether both are a match. The analysis algorithm obtained in the analysis algorithm obtaining module 112 may be used again when the content comparison module 115 performs a comparison operation.

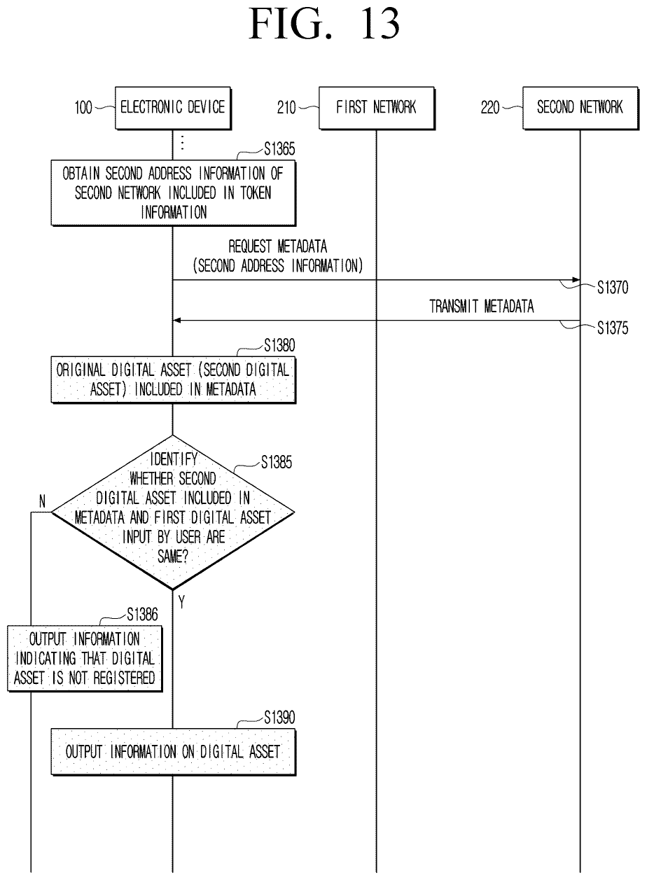

FIG. 13 is a flowchart illustrating a content comparison operation.

Steps S1365, S1370, S1375, and S1390 in FIG. 13 may correspond to steps S1365, S1370, S1375, and S1390 in FIG. 11. Accordingly, redundant descriptions thereof will be omitted. Steps S1105 to S1160 in FIG. 11 may also be applied identically in FIG. 13.

After the electronic device 100 receives the metadata from the second network 220, the electronic device 100 may obtain the digital asset included in the metadata (S1380).

The digital asset input by the user in steps S1105 to S1110 in FIG. 11 may be described as the first digital asset (or first content). The digital asset included in the metadata may be described as the second digital asset (or second content).

The electronic device 100 may identify whether the second digital asset included in the metadata and the first digital asset input (or selected) by the user are the same (S1385). If the second digital asset and the first digital asset are not the same (S1385-N), the electronic device 100 may output information indicating that the first digital asset which the user requested to verify is not registered (S1386).

If the second digital asset is same as the first digital asset (S1385-Y), the electronic device 100 may output the information on the digital asset (S1390). The electronic device 100 may output the information on the digital asset based on at least one from among the token information or the metadata. Step 1390 may include an operation for outputting information indicating that the first digital asset which the user requested to verify is registered.

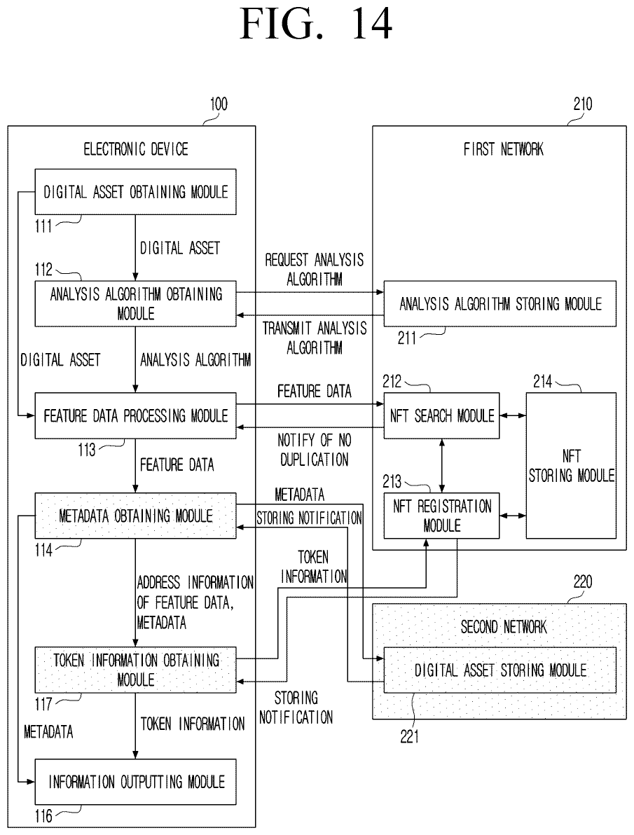

FIG. 14 illustrates an NFT registration operation.

The digital asset obtaining module 111, the analysis algorithm obtaining module 112, the feature data processing module 113, the metadata obtaining module 114, the information outputting module 116, the analysis algorithm storing module 211, the NFT search module 212, the NFT registration module 213, the NFT storing module 214, and the digital asset storing module 221 in FIG. 14 may correspond to the modules described in FIG. 10. Accordingly, redundant descriptions thereof will be omitted.

Referring to FIG. 14, the electronic device 100 may further include a token information obtaining module 117. The electronic device 100 may receive a user input for registering a specific digital asset. There may be a need for the electronic device 100 to determine whether the specific digital asset has been pre-registered before registering the specific digital asset.

Accordingly, the electronic device 100 may determine whether there is a duplicate by transmitting the feature data of the digital asset to the first network 210.

The feature data processing module 113 may transmit the feature data corresponding to the digital asset to the NFT search module 212. The NFT search module 212 may analyze the plurality of tokens stored in the NFT storing module 214.

There is no token corresponding to the feature data. The NFT search module 212 may transmit a signal notifying that there is no token corresponding to the feature data (notifying of no duplication) to the feature data processing module 113.

The feature data processing module 113 may receive the notification that there is no duplication from the NFT search module 212. When the notification that there is no duplication is received, the feature data processing module 113 may transmit the feature data to the metadata obtaining module 114.

The metadata obtaining module 114 may receive the feature data from the feature data processing module 113. The metadata obtaining module 114 may obtain the metadata based on a user input or a pre-set control command associated with the metadata. For example, the user may input the metadata directly. The metadata obtaining module 114 may transmit the metadata to the digital asset storing module 221 of the second network 220.

The digital asset storing module 221 may receive the metadata from the metadata obtaining module 114. The digital asset storing module 221 may store the received metadata. The digital asset storing module 221 may transmit a storing notification to the metadata obtaining module 114.

The metadata obtaining module 114 may receive the storing notification from the digital asset storing module 221. When the storing notification is received, the metadata obtaining module 114 may transmit the metadata to the information outputting module 116.

After obtaining the metadata, the metadata obtaining module 114 may transmit the feature data and at least one information included in the metadata to the token information obtaining module 117. The at least one information included in the metadata may mean information necessary in NFT registration. The information necessary in NFT registration may include the address information of the metadata. The token information obtaining module 117 may obtain the feature data of the digital asset and the at least one information included in the metadata from the metadata obtaining module 114. The token information obtaining module 117 may obtain the feature data, at least one information included in the metadata, and the token information based on the user input (or a pre-set control command associated with the token). The token information may include the feature data. The at least one information included in the token information may be input by the user. For example, the user may directly input the token information. The token information obtaining module 117 may transmit the token information to the NFT registration module 213.

The NFT registration module 213 may receive the token information from the token information obtaining module 117. The NFT registration module 213 may generate a token (NFT) based on the token information. The NFT registration module 213 may register (or store) the generated token in the NFT storing module 214.

After storing the token in the NFT storing module 214, the NFT registration module 213 may transmit the storing notification in the token information obtaining module 117.

The token information obtaining module 117 may receive the storing notification from the NFT registration module 213. When the storing notification is received, the token information obtaining module 117 may transmit the token information to an output module 116.

The information outputting module 116 may receive the metadata from the metadata obtaining module 114. In addition, the information outputting module 116 may receive the token information from the token information obtaining module 117. The information outputting module 116 may output the information on the digital asset based on the token information or the metadata.

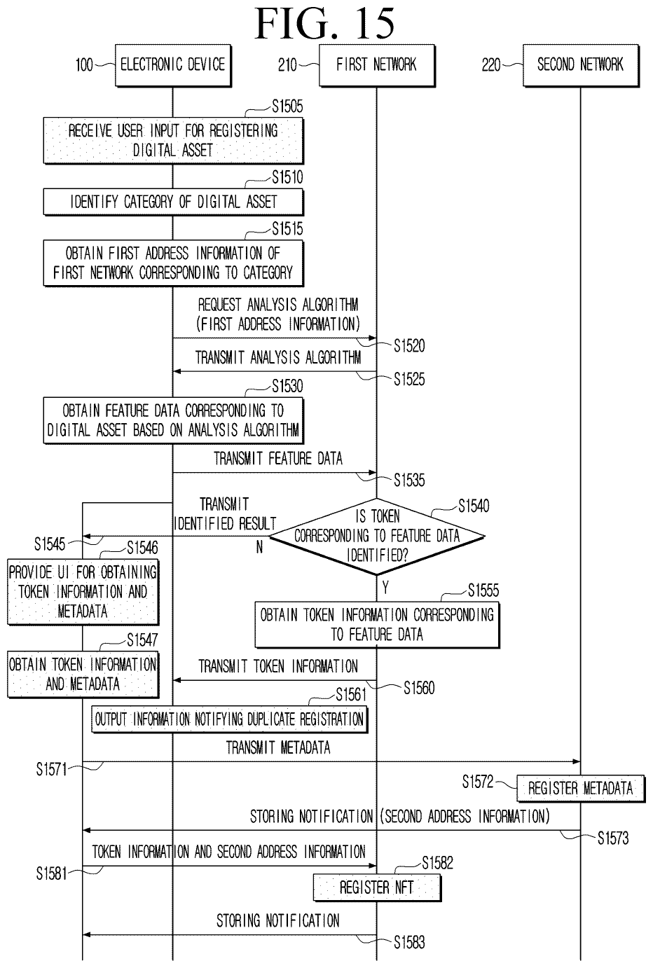

FIG. 15 is a flowchart illustrating an NFT registration operation.

Steps S1510, S1515, S1520, S1525, S1530, S1535, S1540, S1545, S1555, and S1560 in FIG. 15 may correspond to steps S810, S815, S820, S825, S830, S835, S840, S845, S855, and S860 in FIG. 8. Accordingly, redundant descriptions thereof will be omitted.

The electronic device 100 may receive a user input for registering the digital asset (S1505). Then, the electronic device 100 may perform steps S1510 to S1540. To prevent duplicate registration, there may be a need for an operation for looking up the digital asset to be performed before the step of registering the digital asset.

If the token corresponding to the feature data is identified (S1540-Y), the first network 210 may obtain the token information corresponding to the feature data (S1555). The first network 210 may transmit the token information to the electronic device 100 (S1560).

The electronic device 100 may receive the token information from the first network 210. When the token information is received, the electronic device 100 may output information notifying that it is a duplicate registration (S1561). When the token information is received, the electronic device 100 may determine that the token including the same feature data as the digital asset is pre-stored in the first network 210. Accordingly, the electronic device 100 may output information notifying the user of a duplicate registration. The electronic device 100 may output information notifying that registration for the digital asset is not possible to the user.

When the identified result indicating that the token corresponding to the feature data is not identified is received in the electronic device 100, the electronic device 100 may provide a UI for obtaining the token information and the metadata (S1546). The user may input the token information and the metadata through the provided UI. The electronic device 100 may obtain the token information and the metadata through the UI (S1547).

When the token information and the metadata are obtained, the electronic device 100 may transmit the metadata to the second network 220 (S1571).

The second network 220 may receive the metadata from the electronic device 100. The second network 220 may register (or store) the metadata (S1572). The second network 220 may obtain the second address information in which the metadata is stored. The second network 220 may transmit the storing notification to the electronic device 100. The second address information may be included in the storing notification.

The electronic device 100 may receive the storing notification (second address information) from the second network 220.

The electronic device 100 may transmit the token information and the second address information to the first network 210 (S1581).

The first network 210 may receive the token information and the second address information from the electronic device 100. The first network 210 may register (or store) the NFT (token) based on the token information and the second address information (S1582). The first network 210 may transmit the storing notification to the electronic device 100 (S1583). FIG. 16 illustrates the first network 210.

Referring to FIG. 16, the first network 210 may include at least one from among a smart contract 210-1 or a blockchain network 210-2.

The smart contract 210-1 may be a program which executes a transaction associated with a blockchain. The smart contract 210-1 may be a program in which a pre-defined operation (or code) is automatically executed when a pre-defined specific condition is met (or satisfied). The smart contract 210-1 may be a protocol (or a script) authorizing a transaction that is generated in the blockchain network 210-2.

The smart contract 210-1 may include at least one from among the analysis algorithm storing module 211, the NFT search module 212, and the NFT registration module 213.

When a first condition is satisfied, the smart contract 210-1 may provide the analysis algorithm using the analysis algorithm storing module 211.

When a second condition is satisfied, the smart contract 210-1 may search for an NFT corresponding to a target (feature data of the digital asset) using the NFT search module 212.

When a third condition is satisfied, the smart contract 210-1 may register (or store) the digital asset selected (or input) by the user in the blockchain network 210-2 using the NFT registration module 213.

The blockchain network 210-2 may include the NFT storing module 214. The NFT storing module 214 may be implemented with one software or one hardware. However, according to an embodiment, the NFT storing module 214 may be implemented by a plurality of devices using a distribution network.

The smart contract 210-1 may store an analysis algorithm for calculating the feature data to specify the digital asset. The analysis algorithm may include at least one from among an implementation method, a source code, or an execution position. The feature data may be obtained through the analysis algorithm, and the feature data may be used in a search function of the NFT or a registration function, or the like.

In one embodiment, the smart contract 210-1 may be described as a smart contract managing module or a smart contract managing network.

In FIG. 16, the smart contract 210-1 has been described as being separate from the blockchain network 210-2, but according to an embodiment, the smart contract 210-1 may be a concept included in the blockchain network. The smart contract 210-1 may be recorded in the blockchain network.

FIG. 17 illustrates a mapping table.

The smart contract 210-1, the blockchain network 210-2, the analysis algorithm storing module 211, the NFT search module 212, the NFT registration module 213, and the NFT storing module 214 in FIG. 17 may correspond to the configurations in FIG. 16. The analysis algorithm obtaining module 112 in FIG. 17 may correspond to the configuration in FIG. 7. Accordingly, redundant descriptions thereof will be omitted.

Referring to FIG. 17, the analysis algorithm obtaining module 112 of the electronic device 100 may include at least one from among a smart contract registration module 112-1, a smart contract search module 112-2, and a mapping table storing module 112-3.

The smart contract registration module 112-1 may be a module that generates a smart contract based on a user (or developer) input. The smart contract registration module 112-1 may transmit the generated smart contract to the first network 210. The generated smart contract may be stored in the first network 210.

The smart contract search module 112-2 may identify the smart contract associated with the digital asset. The smart contract search module 112-2 may identify (or search) a specific smart contract corresponding to the digital asset from among a plurality of smart contracts.

The smart contract search module 112-2 may request the analysis algorithm to the smart contract 210-1 of the first network 210. The analysis algorithm storing module 211 of the smart contract 210-1 may transmit the analysis algorithm to the smart contract search module 112-2 in response to the request. The smart contract search module 112-2 may use the mapping table storing module 112-3 for identifying the smart contract 210-1 to request the analysis algorithm.

The mapping table storing module 112-3 may store address information (first address information) of the smart contract. The mapping table may include the address information of the smart contract corresponding to the digital asset. The mapping table may include a blockchain name (or identification information) corresponding to the digital asset.

Table 1710 may be a mapping table including a blockchain corresponding to each of the categories of the digital asset and the address information of the smart contract corresponding to each of the digital asset categories.

In an example, the mapping table may include the address information of the smart contract (or address information of the network) corresponding to each of the categories of the digital asset.

Referring to Table 1710, a digital asset in an image category may be stored in an A network, and the digital asset in the image category may have to use a smart contract having address information of “754A456EBD456CFFB”. A digital asset in an audio category may be stored in the A network, and the digital asset in the audio category may have to use a smart contract having address information of “DEF5656FA44B334BC”.

Even if having the same category, different block chains or different smart contracts from each other may be used. A digital asset in the audio category may be stored in a B network, and the digital asset in the audio category may have to use a smart contract having address information of “44B334BCDEF5656FA”.

In an example, the mapping table may include the address information of the smart contract corresponding to each of the plurality of digital assets.

FIG. 18 illustrates an NFT and metadata.

Embodiment 1810 in FIG. 18 may indicate an NFT including at least one from among a network name, identification information, owner information, feature data, and address information of the metadata. The network name may be a blockchain name. The identification information may mean a number of a token in which the NFT is stored. The owner information may mean unique identification information of an owner (or owner address) who owns the NFT. The feature data may mean the feature data of the digital asset for registering as the NFT. According to an embodiment, the analysis algorithm may be included in the NFT.

Embodiment 1820 in FIG. 18 may indicate an NFT including at least one from among the network name, the identification information, the owner information, and the address information of the metadata. Unlike the NFT in embodiment 1810, the NFT in embodiment 1820 may use the feature data itself as the identification information. The feature data may mean unique information of the digital asset for registering in the NFT. Accordingly, the NFT may use the feature data itself as the identification information.

Embodiment 1830 in FIG. 18 may indicate metadata including at least one from among a content, a name, date and time of generation, an author, description information, and address information of content. The content may mean original data of the digital asset. The original data has a problem of it being difficult to be stored in the NFT itself due to data size. Accordingly, the original data may be included in the metadata and stored in a separate server or a separate network.

The name may mean a name of the digital asset (content). The date and time of generation may be a time-point at which the digital asset is generated or registered. The author may mean a person or a company that created the digital asset. The description information may mean text information describing the digital asset. The address information of content may be an address of a web page for accessing (or connecting) the digital asset with associated information (content).

According to an embodiment, the metadata may include the address information of the metadata. The address information of the metadata may be the address of the web page for accessing (or connecting) the digital asset with the associated information (metadata).

FIG. 19 illustrates an operation for outputting an NFT search result.

Referring to FIG. 19, the electronic device 100 may output a screen 1900 including information associated with the digital asset. The screen 1900 may include a UI 1910 indicating a target of search, and a UI 1920 indicating a search result.

The UI 1910 may include the digital asset (first digital asset) input (or selected) by the user. The first digital asset may be an image captured by the user or an image captured on-line.

The electronic device 100 may identify the registered NFT using the feature data of the first digital asset input by the user. The electronic device 100 may obtain the token information based on the identified NFT. The electronic device 100 may obtain the metadata corresponding to the identified NFT. The electronic device 100 may output the result information based on the token information and the metadata.

The UI 1920 may include result information of the first digital asset which the user requested a search on. The result information may mean the information on the digital asset. The result information may include at least one from among the content (second digital asset), the name, the date and time of generation, the author, the description information, the network name, and the owner information. The electronic device 100 may generate (or obtain) result information to be output based on the token information and the metadata.

FIG. 20 illustrates an operation for searching an NFT with only a portion of a digital asset.

Referring to FIG. 20, the electronic device 100 may output a screen 2000 including information associated with the digital asset. The screen 2000 may include a UI 2010 indicating a target of search, and a UI 2020 indicating a search result.

The electronic device 100 may search the original digital asset with only a portion of the digital asset. In FIG. 19, the first digital asset input (or selected) by the user includes all of the original data (second digital asset). In FIG. 20, the first digital asset includes only a portion of the area of the original data (second digital asset).

The electronic device 100 may obtain the feature data based on the first digital asset including only a portion of the area. The electronic device 100 may search the registered NFT using the feature data. Because the first digital asset includes only a portion of the area of the original data, the feature data may also include only a portion of the original data. However, the electronic device 100 may search the registered NFT with only a portion of the original data.

An operation for searching the registered NFT using a portion of data may be applied with an operation for using similarity. Descriptions associated with similarity have been described in FIG. 9.

The image included in the UI 2010 may include only a portion of an area of the image included in UI 1910 in FIG. 19.

The result information included in the UI 2020 may be same as a result image included in the UI 1920 in FIG. 19.

FIG. 21 illustrates an NFT purchase operation or an NFT lookup (or inquiry) operation.

Referring to FIG. 21, the electronic device 100 may output a screen 2100 including information associated with the digital asset. The screen 2100 may include at least one from among a UI 2110 indicating a search result, a UI 2120 for purchasing the searched NFT, and a UI 2130 for looking up additional information of the searched NFT.

The UI 2110 may be same as the UI 1920 in FIG. 19 and the UI 2020 in FIG. 20.

The UI 2120 may include information for guiding a purchase of the searched NFT. The UI 2120 may include at least one from among a guide UI for purchasing the NFT, text information associated with the NFT purchase, or address information of a web page in which the NFT can be purchased.

The UI 2130 may include information for guiding a lookup of additional information of the searched NFT. The UI 2130 may include at least one from among a guide UI for looking up additional information of the NFT, text information associated with the looking up of additional information, or address information of a web page for looking up additional information.

FIG. 22 illustrates a screen that is output when NFT is not found in a search.

Referring to FIG. 22, the electronic device 100 may output a screen 2200 including information associated with the digital asset. The screen 2200 may be a screen that is output when the registered NFT is not identified based on the digital asset input by the user. The screen 2200 may include a UI 2210 indicating a target of search, and a UI 2220 indicating a search result.

The UI 2210 may be same as the UI 1910 in FIG. 19.

The UI 2220 may include at least one from among a sub UI 2221 indicating that the NFT corresponding to the target of search is not found, a sub UI 2222 guiding to recapture the digital asset, a sub UI 2223 guiding to search the NFT in another network, and a sub UI 2224 guiding to register the target of search as the NFT.

The UI 2221 may include text information indicating that the NFT associated with the first digital asset input by the user has not been found.

The UI 2222 may include text information and a guide UI requesting a new input data (digital asset) for re-executing the search operation.

The UI 2223 may include text information and a guide UI guiding for a search operation to be performed with respect to a new network (next rated network) rather than a pre-set network.

The UI 2224 may include text information and a guide UI guiding to register NFT for the target of search.

FIG. 23 illustrates an operation for outputting an NFT similar with a digital asset.

Referring to FIG. 23, the electronic device may output a screen 2300 including information associated with the digital asset. The screen 2300 may be a screen that is output when the registered NFT is not identified based on the digital asset input by the user. The screen 2300 may include a UI 2310 indicating a target of search, and a UI 2320 indicating a search result.

The UI 2310 may be same as the UI 1910 in FIG. 19.

The UI 2320 may include at least one from among a sub UI 2321 indicating that the NFT corresponding to the target of search is not found, a sub UI 2322 indicating similarity of an NFT similar with the target of search, and a sub UI 2323 indicating the digital asset of the NFT similar with the target of search.

The UI 2321 may include text information indicating that the NFT associated with the first digital asset input by the user has not been found.

The UI 2322 may include at least one from among information indicating that there is a most similar NFT rather than the same (or of a same category) NFT or similarity of the most similar NFT. The user may easily find out the degree of similarity through the UI 2322.

The UI 2323 may include the digital asset corresponding to the similar NFT. The digital asset may be original data or thumbnail data. According to an embodiment, the UI 2320 may include only the digital asset (e.g., image) associated with the similar NFT.

By providing the user with the most similar NFT despite it not being the same NFT, inaccuracy of the digital asset input (or selected) by the user directly may be supplemented. For example, if the user is unable to accurately capture the digital asset or if the digital asset is not clear for environmental reasons (brightness), the accuracy of the search operation may decrease. The electronic device 100 may request to the user directly for verification by providing the similar NFT. The user may directly verify whether the similar NFT is the NFT that the user desired to find through the provided screen 2300.

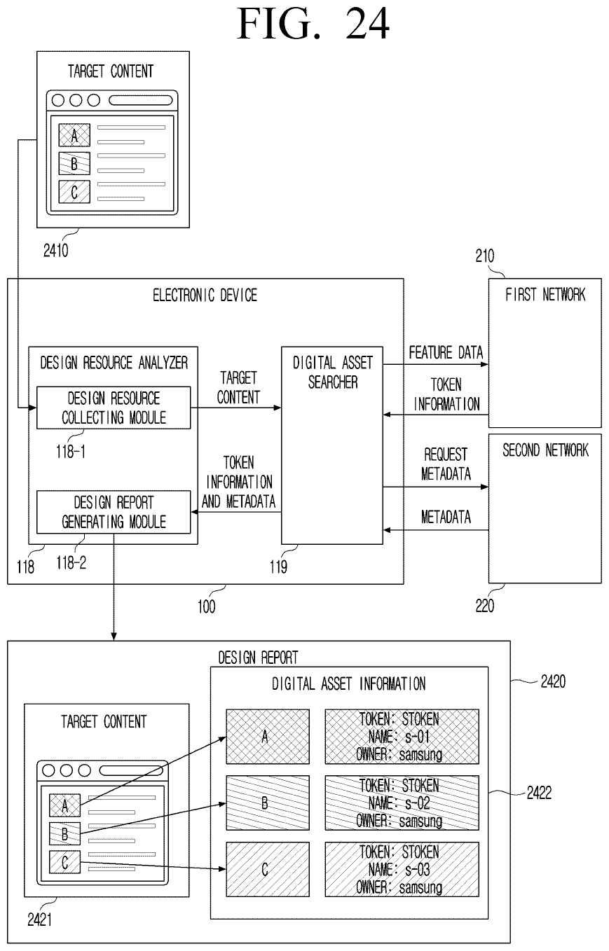

FIG. 24 illustrates an operation for analyzing a design resource with respect to a target homepage.

Referring to FIG. 24, the electronic device 100 may include a design resource analyzer 118 and a digital asset searcher 119.

The design resource analyzer 118 may be a module that analyzes the digital asset included in a target content 2410. The design resource analyzer 118 may include a design resource collecting module 118-1 and a design report generating module 118-2.

The target content 2410 may include the digital asset. For example, the target content 2410 may be an image, a web page, or a digital document.

The design resource collecting module 118-1 may be a module for obtaining the target content 2410. The target content 2410 may be input by the user. The design resource collecting module 118-1 may obtain (or extract) a design resource from the obtained target content 2410. For example, the design resource collecting module 118-1 may extract an image (A, B, C, etc.) associated with the design resource from the target content 2410. The design resource collecting module 118-1 may transmit the extracted image (A, B, C, etc.) to the digital asset searcher 119.

The digital asset searcher 119 may be a module for obtaining the input information on the digital asset. The digital asset searcher 119 may include at least one from among the digital asset obtaining module 111, the analysis algorithm obtaining module 112, the feature data processing module 113, the metadata obtaining module 114, and the information outputting module 116 in FIG. 12.

The digital asset searcher 119 may perform a search operation for the image (A, B, C, etc.) transmitted from the design resource collecting module 118-1. The digital asset searcher 119 may obtain the feature data corresponding to each of the images based on an analysis algorithm corresponding to each of the images. The digital asset searcher 119 may obtain at least one from among the token information or the metadata corresponding to each of the images based on the feature data corresponding to each of the images.

The digital asset searcher 119 may transmit the feature data corresponding to each of the images to the first network 210, and request the token information corresponding to the feature data to the first network 210. The first network 210 may transmit the token information corresponding to the feature data to the digital asset searcher 119.

The digital asset searcher 119 may request metadata corresponding to the digital asset to the second network 220 based on the second address information included in the token information. The second network 220 may transmit the metadata corresponding to the digital asset to the digital asset searcher 119.

The digital asset searcher 119 may transmit at least one from among the obtained token information and the metadata to the design report generating module 118-2.

The design report generating module 118-2 may generate a design report 2420 corresponding to the target content 2410 based on at least one from among the received token information and the metadata.

The design report 2420 may include at least one from among a UI 2421 indicating the target content 2410 or a UI 2422 indicating information associated with the digital asset included in the target content 2410.

The UI 2421 may include a summary image or a thumbnail image of the target content 2410.

The UI 2422 may include the information on the digital asset included in the target content 2410. For example, “A” image is included in the target content 2410. The UI 2422 may include at least one from among a token in which the “A” image is stored (Stoken), a unique name (s-01) of the “A” image, and the owner (Samsung) of the registered token.

The owner of the digital asset may easily identify content infringing his/her right through the design report. In addition, the producer who produced the target content may also easily identify whether his/her content is infringing upon the right of others.

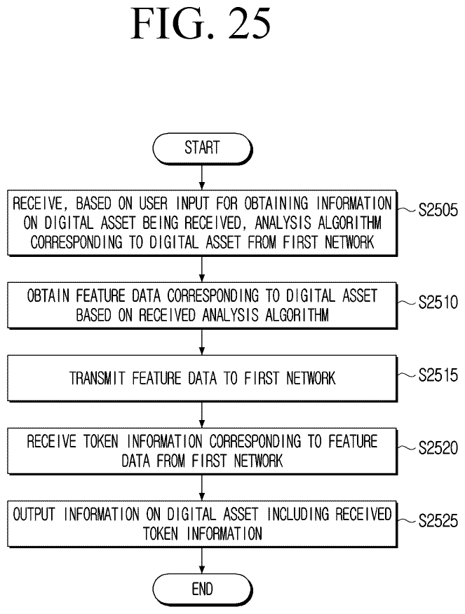

FIG. 25 illustrates a control method of the electronic device 100 according to an embodiment of the disclosure.

Referring to FIG. 25, a control method of the electronic device may include receiving, based on the user input for obtaining the information on the digital asset being received, the analysis algorithm corresponding to the digital asset from the first network (S2505), obtaining the feature data corresponding to the digital asset based on the received analysis algorithm (S2510), transmitting the feature data to the first network (S2515), receiving the token information corresponding to the feature data from the first network (S2520), and outputting the information on the digital asset including the received token information (S2525).

In one embodiment, the outputting the information on the digital asset (S2525) may include outputting, based on receiving the signal indicating that the token corresponding to the feature data is stored in the first network and the token information from the first network, the information on the digital asset including the received token information.

In one embodiment, the control method may further include identifying the category of the digital asset, obtaining the first address information of the first network corresponding to the identified category, and transmitting the signal requesting the analysis algorithm to the first network based on the first address information.

In one embodiment, the electronic device may store the mapping table including the network address information for each category, and the obtaining the first address information may include obtaining the first address information corresponding to the identified category based on the mapping table stored in the electronic device.

In one embodiment, the first network may be configured to store the at least one non-fungible token (NFT), and the transmitting the feature data to the first network (S2515) may include transmitting, to the first network, the signal requesting to identify whether the feature data and an NFT token corresponding to the feature data are included in the first network.

In one embodiment, the token information may include at least one from among the identification information of the token, the owner information of the token, the feature data corresponding to the token, and the address information in which metadata corresponding to the token is stored.

In one embodiment, the control method may further include obtaining the second address information in which the metadata corresponding to the token is stored based on the token information, transmitting the signal requesting the metadata to the second network based on the second address information, and receiving the metadata from the second network.

In one embodiment, the metadata may include at least one from among content corresponding to the token, the name of the content, the date and time of generation of the content, the author of the content, and the description information corresponding to the content.

In one embodiment, the outputting the information on the digital asset (S2525) may include outputting the information on the digital asset including at least one from among the token information and the metadata.

In one embodiment, the control method may further include outputting, based on receiving the signal indicating that the token corresponding to the feature data is not stored in the first network from the first network, the information indicating that the token corresponding to the input data is not identified.

In one embodiment, the control method of the electronic device as shown in FIG. 25 may be executed on the electronic device having the configurations of FIG. 2 or FIG. 3, and may be executed on the electronic device having configurations in addition thereto.

In one embodiment, the methods according to the one or more embodiments of the disclosure described above may be implemented in an application form installable in electronic devices of the related art.

In addition, the methods according to the one or more embodiments of the disclosure described above may be implemented with only a software upgrade, or a hardware upgrade for the electronic device of the related art.

In addition, the one or more embodiments of the disclosure described above may be performed through an embedded server provided in the electronic device, or at least one external server from among the electronic device and the display device.

According to an embodiment of the disclosure, the one or more embodiments described above may be implemented with software including instructions stored in a machine-readable storage media (e.g., a computer). The machine may call a stored instruction from a storage medium, and as a device operable according to the called instruction, may include the electronic device according to the above-mentioned embodiments. Based on a command being executed by the processor, the processor may directly or using other elements under the control of the processor perform a function relevant to the command. The command may include a code generated by a compiler or executed by an interpreter. The machine-readable storage media may be provided in a form of a non-transitory storage medium. Herein, ‘non-transitory’ merely means that a storage medium is tangible and does not include a signal, and the term does not differentiate data being semi-permanently stored or being temporarily stored in the storage medium.

In addition, according to an embodiment of the disclosure, a method according to the one or more embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the storage medium such as a server of a manufacturer, a server of an application store, or a memory of a relay server, or temporarily generated.

In addition, each of the elements (e.g., a module or a program) according to one or more embodiments described above may be configured as a single entity or a plurality of entities, and a portion of sub-elements of the above-mentioned sub-elements may be omitted, or other sub-elements may be further included in the one or more embodiments. Alternatively or additionally, a portion of the elements (e.g., modules or programs) may be integrated into one entity to perform the same or similar functions performed by each of the relevant elements prior to integration. Operations performed by a module, a program, or another element, in accordance with one or more embodiments, may be executed sequentially, in a parallel, repetitively, or in a heuristic manner, or at least a portion of the operations may be executed in a different order, omitted, or a different operation may be added.

While the disclosure has been illustrated and described with reference to example embodiments thereof, the embodiments are intended to be illustrative, not limiting. Those skilled in the art would understand that various changes in form and details may be made therein without departing from the true spirit and full scope of the disclosure, including the appended claims and their equivalents.

Throughout the disclosure, the digital asset obtaining module 111 may be replaced with a digital asset obtainer. The analysis algorithm obtaining module 112 may be replaced with an analysis algorithm obtainer. The smart contract registration module 112-1 may be replaced with a smart contract register. The smart contract search module 112-2 may be replaced with a smart contract searcher. The mapping table storing module 112-3 may be replaced with a mapping table storage. The feature data processing module 113 may be replaced with a feature data processor. The metadata obtaining module 114 may be replaced with a metadata obtainer. The content comparison module 115 may be replaced with a content comparator. The information outputting module 116 may be replaced with an information output. The token information obtaining module 117 may be replaced with a token information obtainer. The design resource collecting module 118-1 may be replaced with a design resource collector. The design report generating module 118-2 may be replaced with a design report generator. The analysis algorithm storing module 211 may be replaced with an analysis algorithm storage. The NFT search module 212 may be replaced with an NFT searcher. The NFT registration module 213 may be replaced with an NFT register. The NFT storing module 214 may be replaced with an NFT storage. The digital asset storing module 221 may be replaced with a digital asset storage. The above terms (the digital asset obtainer . . . the digital asset storage) may be implemented with hardware (e.g., a processor, a controller), software (computer codes, programs), or combinations of hardware and software.

What is claimed is:

1. An electronic device comprising:
a memory storing instructions;
a communication interface; and
at least one processor configured to execute the instructions,
wherein the at least one processor is configured to
based on a user input for obtaining information on a digital asset being received, receive, from a first network through the communication interface, an analysis algorithm corresponding to the digital asset,
based on the received analysis algorithm, obtain feature data corresponding to the digital asset,
transmit, to the first network through the communication interface, the feature data,
receive, from the first network through the communication interface, token information corresponding to the feature data, and
output information on the digital asset, wherein the information comprises the received token information.

2. The electronic device of claim 1, wherein the at least one processor is further configured to output, based on receiving a signal, indicating that a token corresponding to the feature data is stored in the first network, and the token information from the first network, information on the digital asset comprising the received token information through the communication interface.

3. The electronic device of claim 1, wherein the at least one processor is further configured to:
identify a category of the digital asset,
obtain first address information of the first network corresponding to the identified category, and
transmit, to the first network through the communication interface, a signal requesting the analysis algorithm, based on the first address information.

4. The electronic device of claim 3, wherein the memory is configured to store a mapping table comprising network address information for each category, and
wherein the at least one processor is further configured to obtain the first address information corresponding to the identified category based on the mapping table stored in the memory.

5. The electronic device of claim 1, wherein the first network is configured to store at least one non-fungible token (NFT), and
wherein the at least one processor is further configured to transmit, to the first network through the communication interface, a signal requesting to identify whether the feature data and the NFT corresponding to the feature data are included in the first network.

6. The electronic device of claim 1, wherein the token information comprises at least one from among identification information of a token, owner information of the token, the feature data corresponding to the token, and address information in which metadata corresponding to the token is stored.

7. The electronic device of claim 6, wherein the at least one processor is further configured to:
obtain second address information in which the metadata corresponding to the token is stored based on the token information,
transmit, to a second network through the communication interface, a signal requesting the metadata, based on the second address information, and
receive, from the second network through the communication interface, the metadata.

8. The electronic device of claim 7, wherein the metadata comprises at least one from among content corresponding to the token, a name of a content, a date and time of generation of the content, an author of the content, and description information corresponding to the content.

9. The electronic device of claim 7, wherein the at least one processor is further configured to output information on the digital asset comprising at least one from among the token information and the metadata.

10. The electronic device of claim 1, wherein the at least one processor is further configured to output, based on receiving a signal indicating that a token corresponding to the feature data is not stored in the first network from the first network, information indicating that the token corresponding to the input data is not identified through the communication interface.

11. A method of an electronic device, the method comprising:
based on a user input for obtaining information on a digital asset being received, receiving, from a first network, an analysis algorithm corresponding to the digital asset;
obtaining feature data corresponding to the digital asset based on the received analysis algorithm;
transmitting, to the first network, the feature data;
receiving, from the first network, token information corresponding to the feature data; and
outputting information on the digital asset comprising the received token information.

12. The method of claim 11, wherein the outputting information on the digital asset comprises outputting, based on receiving a signal, indicating that a token corresponding to the feature data is stored in the first network, and the token information from the first network, information on the digital asset comprising the received token information.

13. The method of claim 11, further comprising:
identifying a category of the digital asset;
obtaining first address information of the first network corresponding to the identified category; and
transmitting, to the first network, a signal requesting the analysis algorithm, based on the first address information.

14. The method of claim 13, wherein the electronic device is configured to store a mapping table comprising network address information for each category, and
wherein the obtaining first address information comprises obtaining the first address information corresponding to the identified category based on the mapping table stored in the electronic device.

15. The method of claim 11, wherein the first network is configured to store at least one non-fungible token (NFT), and
wherein the transmitting the feature data to the first network comprises transmitting, to the first network, a signal requesting to identify whether the feature data and an NFT token corresponding to the feature data are included in the first network.
